(19) United States
(12) Patent Application Publication
(10) Pub. No.: US 2019/0026661 A1
(43) Pub. Date: Jan. 24, 2019

(54) METHOD, APPARATUS, AND COMPUTER-READABLE MEDIUM FOR ARTIFACT TRACKING

(71) Applicant: Sparta Systems, Inc., Hamilton, NJ (US)

(72) Inventors: Cindy Cortell, Princeton Junction, NJ (US); Amy Sidelinger, Hightstown, NJ (US)

(21) Appl. No.: 15/657,824

(22) Filed: Jul. 24, 2017

(51) Int. Cl. G06Q 10/06

(52) U.S. Cl. CPC G06Q 10/0631

(57) ABSTRACT

A system, method and computer-readable medium for artifact tracking including receiving audit information corresponding to an audit, determining artifacts necessary for compliance with a controls based at least in part on control information associated with the controls and the audit information, generating control data structures corresponding to the controls, linking the control data structures to departments in an organization designated to provide the artifacts indicated by the control data structures, storing the control data structures in a secured folder structure configured to provide access to linked departments and to link uploaded artifacts with a corresponding control data structure, and transmitting a notification to an auditor based on a determination that uploaded artifacts linked to a control data structure correspond to artifacts indicated by the control data structure.

### BACKGROUND

A compliance audit is a comprehensive review of an organization's adherence to regulatory guidelines in which independent accounting, security, or IT consultants (“auditors”) evaluate the strength and thoroughness of an organization's compliance with a particular set of standards.

Security and compliance documents are known as audit artifacts. Examples of audit artifacts include Service Organization Control (SOC) reports, Payment Card Industry (PCI) reports, and certifications from accreditation bodies across geographies and compliance verticals that validate the implementation and operating effectiveness of Amazon Web Services (AWS) security controls.

The audit artifacts that are examined in a compliance audit can vary depending upon whether an organization is a public or private company, what kind of data it handles and if it transmits or stores sensitive financial data. For example, Sarbanes-Oxley (SOX) compliance may require that any electronic communication must be backed up and secured with reasonable disaster recovery infrastructure. Healthcare providers that store or transmit e-health records, like personal health information, are subject to the Health Insurance Portability and Accountability Act of 1996 (HIPAA) requirements. Financial services companies that transmit credit card data are subject to Payment Card Industry Data Security Standard (PCI DSS) requirements. SOC are a series of accounting standards that measure the control of financial information for a service organization. Each of these audits will typically have hundreds of different controls, each of which measures compliance with a particular requirement of the relevant standard. In each case, an organization must be able to demonstrate compliance by producing the appropriate audit artifacts corresponding to each control for which it is being audited.

A comprehensive audit of an organization frequently requires the production of hundreds or thousands of different audit artifacts, each of which may be provided by an assortment of employees and departments within the organization. The typical process for matching audit artifacts to relevant controls typically relies upon a manual process for each control in which the relevant audit artifacts are provided to an auditor for a particular control. In the context of large scale audits requiring artifacts corresponding to hundreds of controls, this process is time-consuming, computationally inefficient, and frequently error-prone.

Additionally, since audit controls frequently require audit artifacts produced by a variety of departments or employees within an organization, it can be difficult for project managers responsible for compliance to coordinate artifact production requests among the multiple departments of an organization, to ensure that the appropriate employees or departments have access to the relevant controls, to track the progress of those requests among the various departments, and to send the appropriate notifications to the persons responsible for production of particular artifacts.

Furthermore, the current process of providing audit artifacts to auditors poses significant security risks. Not only are audit artifacts exposed outside of the departments responsible for production, but current auditing systems lack security with regard to single sign-on authentication, encryption at REST and in transit. Security is also lacking when communicating audit artifacts between auditee and a certificate body auditor.

Accordingly, improvements are needed in systems for conducting compliance audits and artifact tracking.

### BRIEF DESCRIPTION OF THE DRAWINGS

FIG. 1 illustrates a flowchart for audit tracking according to an exemplary embodiment.

FIGS. 2A-2D illustrates interfaces for receiving audit information according to an exemplary embodiment.

FIG. 3 illustrates a process flow diagram 300 for receiving audit information relating to an audit according to an exemplary embodiment.

FIG. 4 illustrates a flowchart for determining one or more artifacts necessary for compliance with a control according to an exemplary embodiment.

FIG. 5 illustrates an example of querying a database for artifact information corresponding to a control according to an exemplary embodiment.

FIG. 6 illustrates an example of the process of generating control data structures corresponding to controls according to an exemplary embodiment.

FIG. 7 illustrates an example of a control data structure which takes the form of a template having columns for the control number, requested item, author, and version according to an exemplary embodiment.

FIG. 8 illustrates a flowchart for linking a control data structure to at least one department designated to provide one or more artifacts indicated by that control data structure according to an exemplary embodiment.

FIG. 9 illustrates an example of the department determination, mapping, and linking process according to an exemplary embodiment.

FIG. 10 illustrates an example of the linking between control data structures and the departments of an organization according to an exemplary embodiment.

FIG. 11 illustrates an example of the secured folder structure according to an exemplary embodiment.

FIG. 12 illustrates a secured folder structure comprising four distinct secured folders according to an exemplary embodiment.

FIG. 13 illustrates a flowchart for storing a control data structure in a secured folder structure comprising a plurality of secured folders according to an exemplary embodiment.

FIG. 14 illustrates an example of storing a control data structure in a secured folder structure comprising a plurality of secured folders according to an exemplary embodiment.

FIG. 15 illustrates an example of transmitting a notification to an auditor according to an exemplary embodiment.

FIG. 16 illustrates a secured folder structure comprising a plurality of secured folders in which the auditor has authenticated access to one of those folders according to an exemplary embodiment.

FIG. 17 illustrates a flowchart for transitioning a control data structure and uploaded artifacts linked to that control data structure that are stored in a Work-in-Progress (“WIP”) folder to a different secured folder based on a response from an auditor according to an exemplary embodiment.

FIG. 18 illustrates an example of transitioning a control data structure and uploaded artifacts linked to that control data structure that are stored in the WIP folder to a different secured folder based on a response from an auditor according to an exemplary embodiment.

FIG. 19 illustrates another example of transitioning a control data structure and uploaded artifacts linked to that control data structure that are stored in the WIP folder to a different secured folder based on a response from an auditor according to an exemplary embodiment.

FIG. 20 illustrates a flowchart for calculating one or more metrics pertaining to one or more audits according to an exemplary embodiment.

FIGS. 21A-21D illustrate representations of various metrics according to an exemplary embodiment.

FIG. 22 illustrates a flowchart for recommending remedial actions based on a total risk score metric corresponding to an audit according to an exemplary embodiment.

FIGS. 23A-23D illustrate tables used to calculate severity, likelihood, and detectability metrics, overall risk scores, and corresponding remedial actions according to an exemplary embodiment.

FIG. 24 illustrates a flowchart for determining metrics, reporting, and taking corrective actions according to an exemplary embodiment.

FIG. 25 illustrates an exemplary computing environment that can be used to carry out the method for tracking an artifact.

### DETAILED DESCRIPTION

While methods, apparatuses, and computer-readable media are described herein by way of examples and embodiments, those skilled in the art recognize that methods, apparatuses, and computer-readable media for artifact tracking are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “can” is used in a permissive sense (i.e., meaning having the potential to) rather than the mandatory sense (i.e., meaning must). Similarly, the words “include,” “including,” and “includes” mean including, but not limited to.

Applicant has discovered a method, apparatus, and computer-readable medium which allows for tracking of audit artifacts, links audit artifacts to their respective controls, and selectively links audit controls to departments within an organization that are responsible for compliance with those controls. In particular, the present application introduces novel data structures that link required artifact information with audit control information and that further link audit controls and access privileges with departments responsible for compliance with those controls. Additionally, a novel secured folder data structure is disclosed that secures and restricts access to uploaded artifact data and includes logic for dynamically sorting audit controls based on compliance level, auditor feedback, and the detection of uploaded artifacts pertaining to the audit controls.

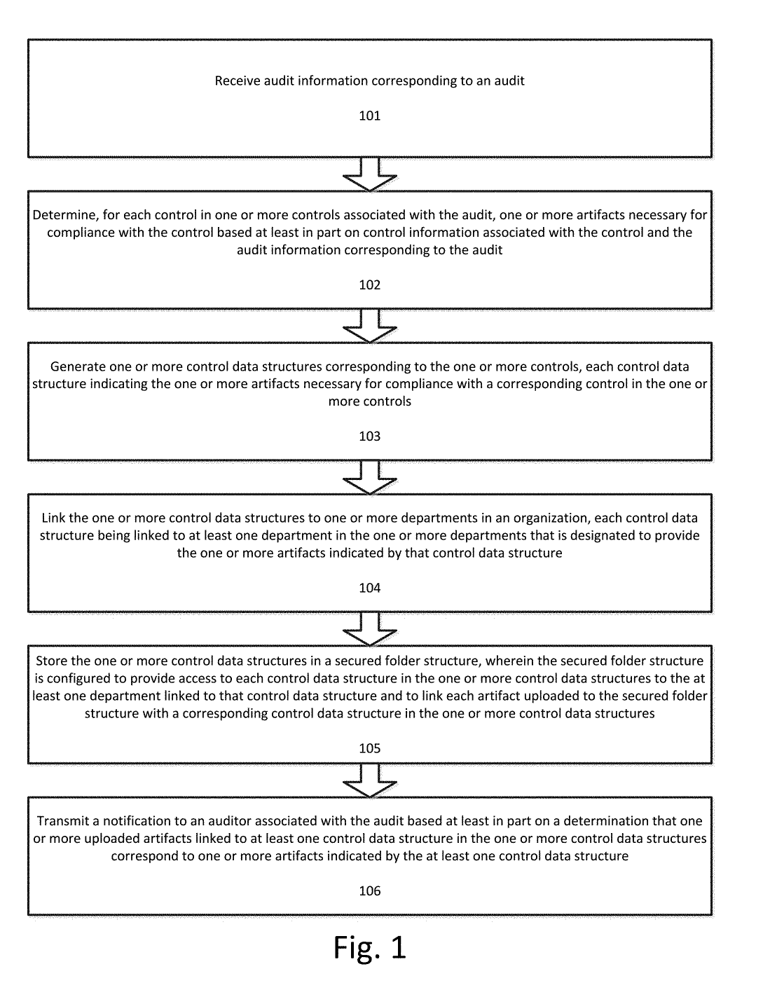

FIG. 1 illustrates a flowchart for audit tracking according to an exemplary embodiment. At step 101 audit information corresponding to an audit is received. The audit information can be provided by a user that is responsible for managing the audit, such as a project manager or other employee, or can alternatively be provided by the auditor who is conducting the audit.

The audit information can include an audit type. Audit type can indicate, for example, whether the audit is an internal audit, a customer or external audit, a regulatory audit, a compliance audit, or a specific type of compliance audit such as an SOC audit, or a SOX audit.

The step of receiving audit information can also include receiving a selection of an audit template, which is a template for a specific type of audit that has associated audit controls. Selection can be received by inputting a template identifier, selecting the template from a menu or drop-down list, or any other means of user input in a user interface, or via electronic transmission (such as via email, electronic upload, etc.). For example a user can first select an audit type of “SOC audit” in an interface and then select an audit template corresponding to a particular set of controls for an SOC audit, such as only security controls or privacy controls. The system can store current versions of multiple audit templates corresponding to each audit type so that a user can select the appropriate audit template for the type of audit they are seeking to manage/conduct. The selection of an audit template by a user results in the automatic selection of the controls corresponding to that audit template. For example, if a user that selects a specific type of SOC audit template, then the system will retrieve that template, look up the controls associated with that template in a lookup table or database, and automatically select the appropriate controls. The audit template can also have the corresponding controls embedded therein so that selection of the audit template results in the selection of the corresponding controls. A user can optionally select more than one audit template if they are managing or conducting an audit of more than one compliance area for a particular audit type. In this case, the controls corresponding to all of the selected audit templates will be selected.

As discussed above, receiving the selection of an audit template automatically results in receiving information about one or more controls associated with the template. These controls can be identified using the appropriate control identifiers for the audit, such as Control Objectives for Information and Related Technology (COBIT) numbers or other control numbers for different types of audits. In addition to, or as an alternative to, selecting audit templates, users can also provide information regarding the specific controls they would like included in the audit. In this case, the user can specify the control numbers corresponding to the controls that they would like included in the audit.

Compliance with controls is typically demonstrated through audit artifacts, which can be records, documents, files, logs, reports, questionnaires, surveys, inspections and inspection documentation, statistics, or any other type of evidence which is offered to demonstrate compliance with the particular control involved. As discussed further below, the present system is configured to automatically identify necessary audit artifacts for each control. However, in certain cases, a user may wish to utilize either additional artifacts, non-standard artifacts, or otherwise alternative artifacts to demonstrate compliance with a particular control. The user can provide information relating to any of these types of additional artifacts when providing the audit information. The artifact information can include an artifact identifier or type, descriptive information about the artifact, or any other information that is used to identify a particular artifact.

The step of receiving audit information can also include receiving information about the organization under audit, employees or departments of the organization, severity or risk information relating to the audit or to the organization, or information for persons responsible for conducting or managing the audit. The received information can include identifying information for an audit owner, such as a project manager or auditor that is responsible for managing or conducting the audit, as well as department information for a department of the project manager (e.g., compliance, information technology, etc.). The severity and risk information can include answers to surveys or questionnaires, metrics calculated based upon those answers, ratings, severity and risk information pertaining to other audits, or any other risk related information.

If a user is accessing an ongoing audit, the step receiving audit information can include receiving identifying information about the audit being accessed, such as audit identifiers, identifiers for control data structures corresponding to controls of the audit, version numbers for control data structures, or any other information required to access a particular ongoing audit.

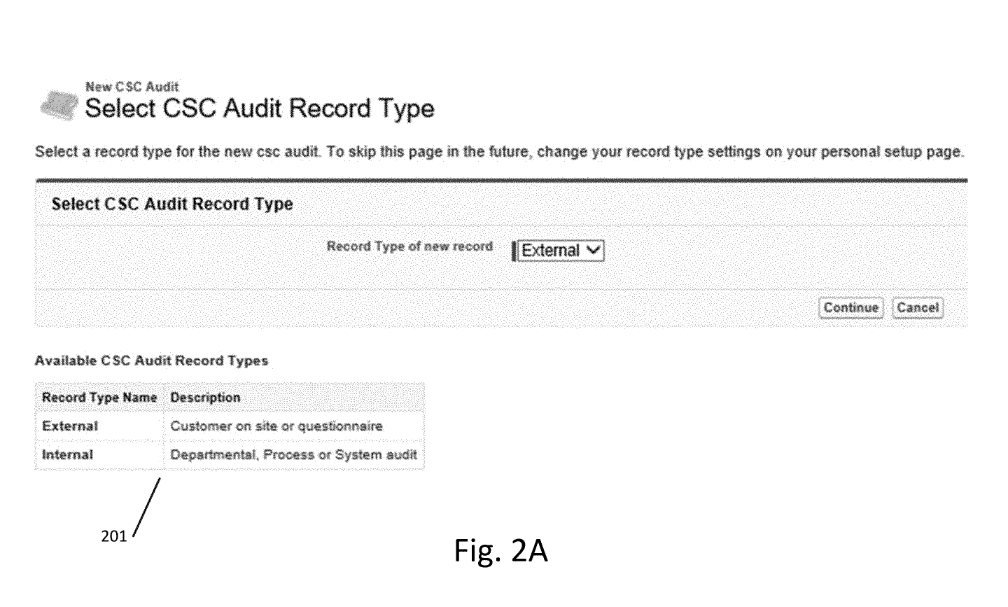

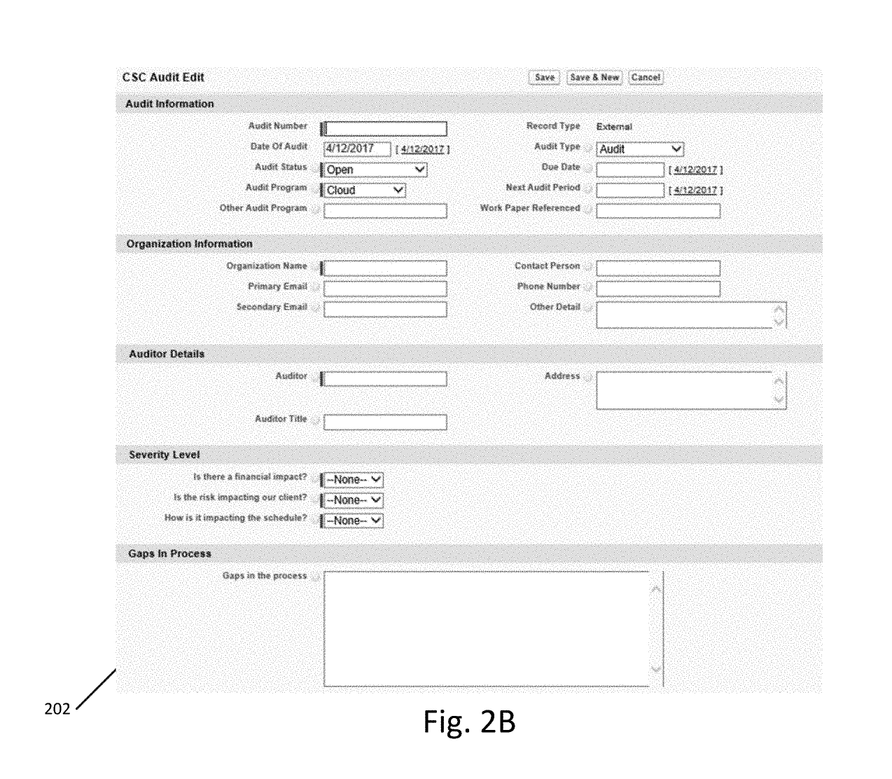

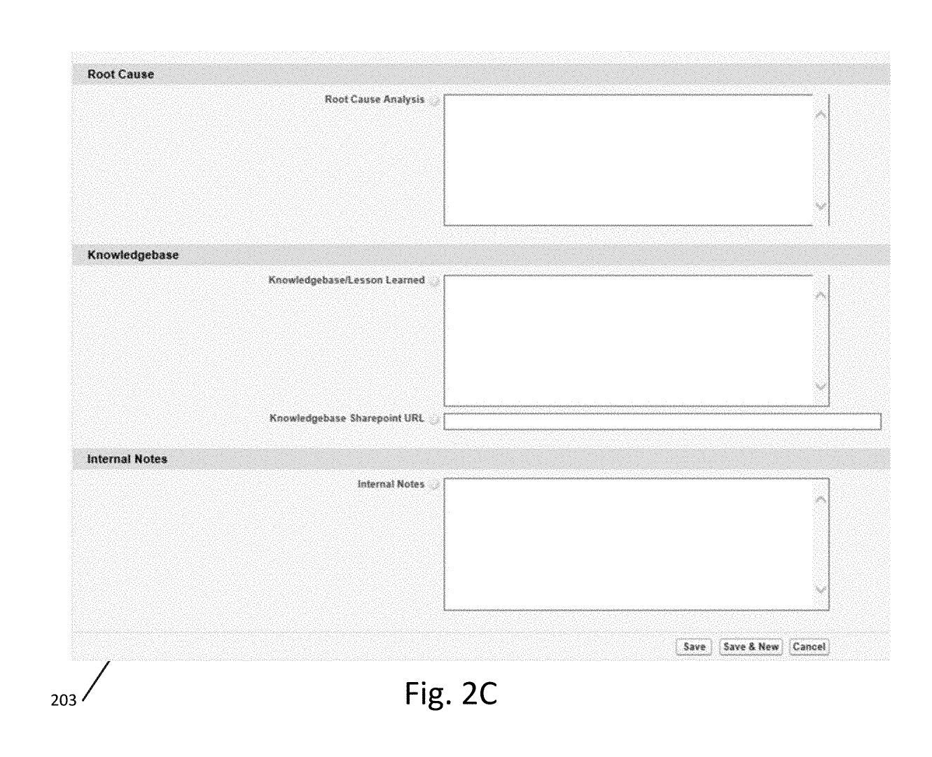

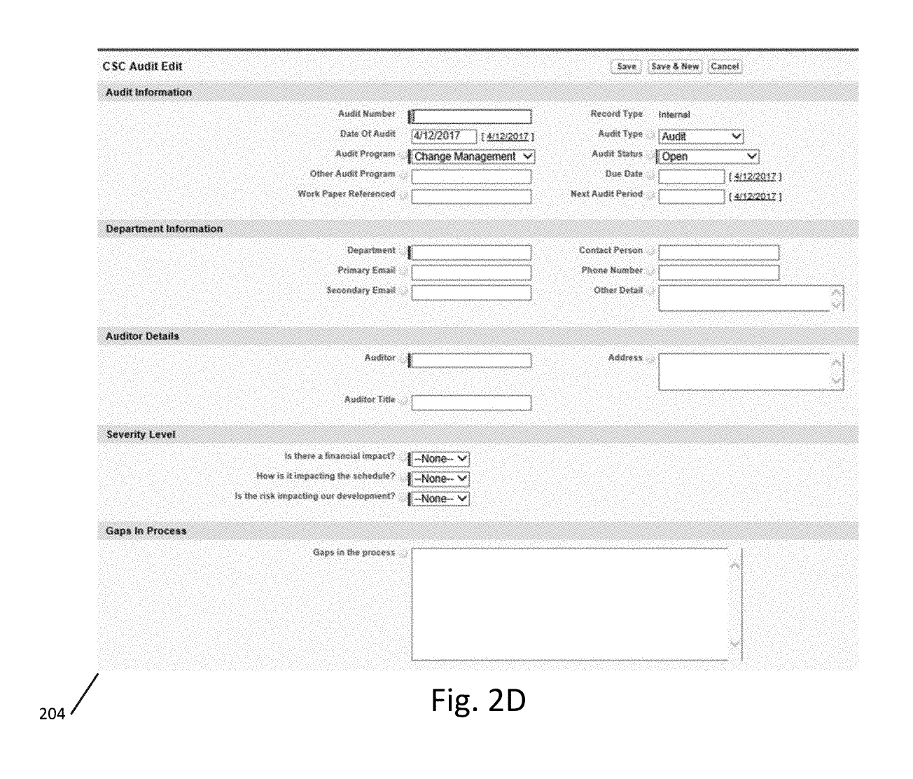

FIG. 2A illustrates an interface 201 for receiving audit information in which a user has selected a Critical Security Controls (CSC) audit and is selecting an audit record type according to an exemplary embodiment. FIG. 2B illustrates another interface 202 for receiving audit information relating to an internal audit which allows users to provide audit information, organization information, auditor information, answers to questions used to determine severity level, and information about gaps in the process according to an exemplary embodiment. FIG. 2C illustrates another interface 203 for receiving audit information which allows users to enter root cause information, information for a shared knowledgebase, and internal notes according to an exemplary embodiment. FIG. 2D illustrates another interface 204 for receiving audit information relating to an external audit which allows users to provide audit information, department information, auditor information, answers to questions used to determine severity level, and information about gaps in the process according to an exemplary embodiment.

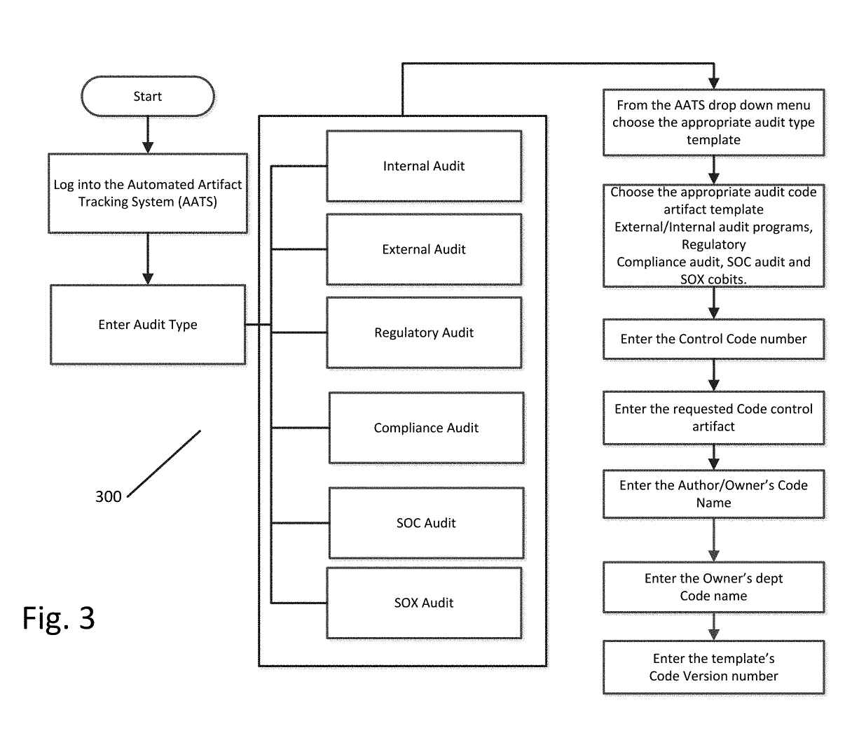

FIG. 3 illustrates a process flow diagram 300 for receiving audit information relating to an audit according to an exemplary embodiment. As shown in the diagram 300, the process begins with the user logging into the system, referred to as an Automated Artifact Tracking System (“AATS”). The user can then select an audit type and provide one or more items of additional information which are discussed above, such as audit template, control codes, artifact information, audit author/owner information, department information, and version information.

The step of receiving audit information results in the determination of one or more controls which are associated with the audit, whether through selection of an audit template, or through user entry of control information. These associated controls correspond to the requirements of the particular audit.

At step 102 of FIG. 1, for each control in the one or more controls associated with the audit, one or more artifacts necessary for compliance with that control are determined based at least in part on control information associated with the control and the audit information corresponding to the audit.

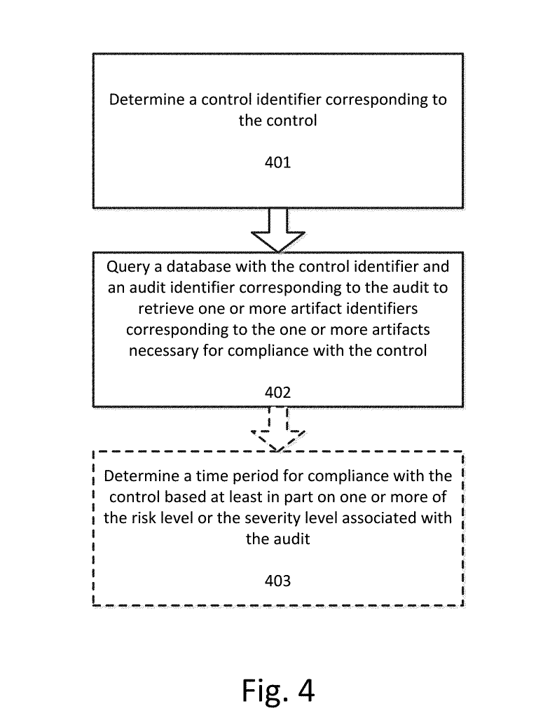

FIG. 4 illustrates a flowchart for determining one or more artifacts necessary for compliance with a control according to an exemplary embodiment. At step 401 a control identifier corresponding to the control is determined. This step can include parsing or analyzing previously determined or received control information. This step can also include looking up the control identifier for a particular control based upon a selected audit template.

At step 402 a database is queried with the control identifier and an audit identifier corresponding to the audit to retrieve one or more artifact identifiers corresponding to the one or more artifacts necessary for compliance with the control. The control identifier and the audit identifier can be used by the database to provide the relevant artifact information. The database can also utilize additional information relating to the audit or to the organization to look up and provide the required artifact information. For example, the query can include information pertaining to the type of organization, structure of the organization, types of documentation available to the organization, or contextual information about the audit that are used by the database in conjunction with the control identifier to retrieve the appropriate artifact identifiers.

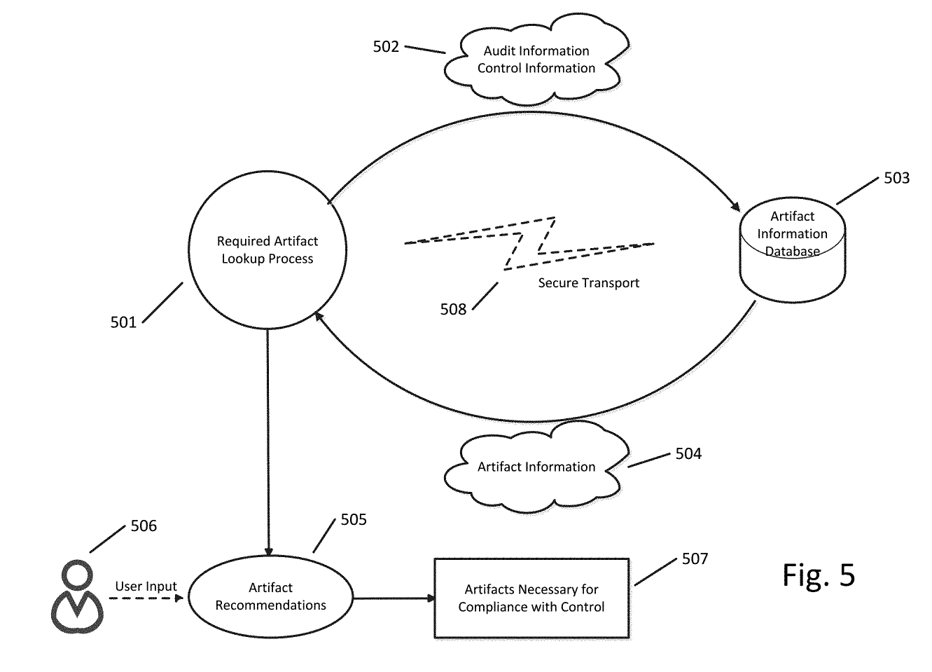

FIG. 5 illustrates an example of querying a database for artifact information corresponding to a control according to an exemplary embodiment. As shown in FIG. 5, a required artifact lookup process transmits a query 502 including audit information and control information to an artifact information database 503. The audit information database 503 is configured to receive queries including control identifiers corresponding to controls and lookup and return artifact information corresponding to artifacts required for compliance with those controls. Artifact information corresponding to each control can be input to the audit information database 503 by subject matter experts or through automated means, such as scraping of relevant compliance web sites and/or materials.

The audit information database 503 can optionally be access over a computer network 508 connecting computing devices at remote locations. Alternatively, the audit information database can be a local stored database. The database can take any form, such as a relational database, a lookup table, or a customized database.

In response to query 502, the audit information database 503 returns artifact information 504 which can include one or more artifact identifiers, artifact descriptors, and/or artifact rankings which rank artifacts that can be used to comply with a control according to some sort criteria, user preferences, or organization information. If multiple different sets of artifacts can be used to comply with a particular control, the artifact information 504 can include artifact groupings and/or rankings of the groups.

The received artifact information 504 is used by the required artifacts lookup process 501 to generate artifact recommendations 505. These artifact recommendations 505 can then be designated as the artifacts necessary for compliance with the control. Optionally, the artifact recommendations 505 can be presented to a user 506, who may then provide input on the artifact recommendations 505 to indicate which artifacts they would like to use to comply with the control. For example, the artifact recommendations 505 can include two different types of document that can be used to show compliance with a control. A user at an organization can decide that only one of these documents is available to the organization, or that one type of document is easier to access, and select that type of document as the artifact they would like to use. The user-selected artifacts would then be designated as the artifacts necessary for compliance with the control 507.

Returning to FIG. 4, at optional step 403, a time period for compliance with the control can be determined based at least in part on one or more of a risk level or a severity level associated with the audit. Risk and severity levels are discussed in greater detail further below, but can be determined based upon the information provided by the user as part of the received audit information or based upon metrics calculated from that information or risk information pertaining to other audits. This step allows the artifact tracking system to internally prioritize certain audits and certain controls over others in order to minimize overall risk.

Returning to FIG. 1, at step 103 of FIG. 1 one or more control data structures corresponding to the one or more controls are generated, each control data structure indicating the one or more artifacts necessary for compliance with a corresponding control in the one or more controls.

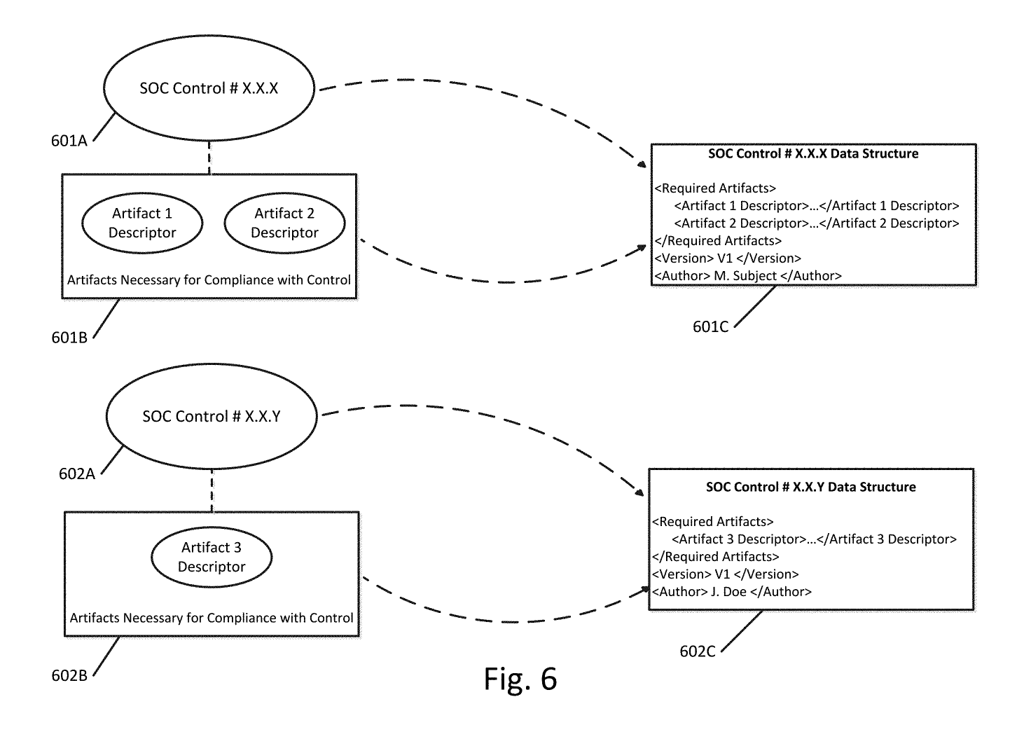

FIG. 6 illustrates an example of the process of generating control data structures corresponding to controls according to an exemplary embodiment. As shown in FIG. 6, information corresponding to control 601A is combined with artifact information 601B to generate control data structure 601C. Information corresponding to control 601A can include a control identifier, descriptive information about the control, information about the audit associated with control, such as the author/owner of the audit, department, etc. Artifact information 601B can include information about the artifacts necessary for compliance with the control, including artifact identifiers, artifact descriptors, or any other artifact information. Generated control data structure 601C includes information about both the corresponding control and the artifacts required to demonstrate compliance with the control. Generated control data structure can also include additional information such as the author/owner of the control and a version number associated with the generated control data structure. As will be discussed further below, this version number can be used to track different stages of the control data object as it proceeds through the audit tracking system.

As further shown in FIG. 6, information corresponding to second control 602A is combined with artifact information 602B to generate control data structure 602C. This control, artifact information, and resulting data structure differ from the first in that only a single artifact is required to demonstrate compliance with the control.

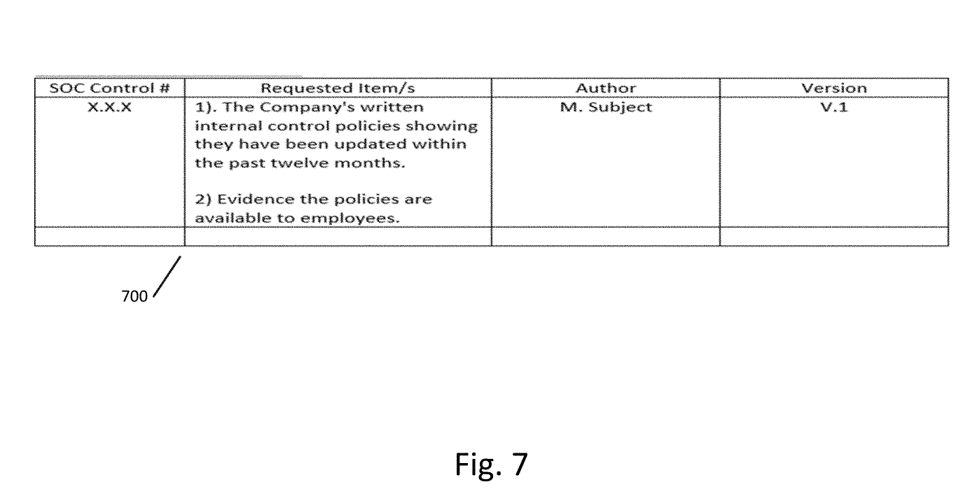

The control data structure can take any form. The internal structure of the control data structures of FIG. 6 are represented using xml descriptions, but the actual data structure can be any type of data structure, such as a special purpose data object, a file record, a table, a document, or any other format which can be used to indicate the artifacts required for compliance with a particular control. For example, FIG. 7 illustrates an example of a control data structure 700 which takes the form a template having columns for the control number, requested item (required artifacts), author, and version according to an exemplary embodiment.

Returning to FIG. 1, at step 104 the one or more control data structures are linked to one or more departments in an organization, each control data structure being linked to at least one department in the one or more departments that is designated to provide the one or more artifacts indicated by that control data structure.

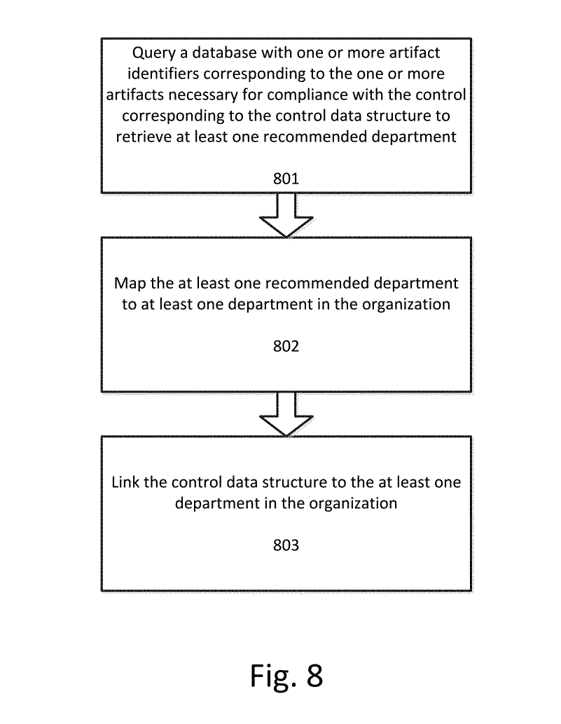

FIG. 8 illustrates a flowchart for linking a control data structure to at least one department designated to provide one or more artifacts indicated by that control data structure according to an exemplary embodiment. At step 801 a database is queried with one or more artifact identifiers corresponding to the one or more artifacts necessary for compliance with the control corresponding to the control data structure to retrieve at least one recommended department.

The recommended department can be the department that would ordinarily be responsible for producing the required artifacts at an enterprise level organization. For example, if the artifact was a certain financial record, then the recommended department would be the accounting department. In another example, if the artifact was a system log tracking web usage, then the recommended department would be the IT department.

At step 802 the at least one recommended department returned by the database is mapped to at least one department in the organization which is being audited. If the organization being audited is an enterprise level organization with a standard organizational structure and departments, then the least one recommended department will frequently be the same as the at least one department in the organization which is being audited. However, if the organizational structure of the organization being audited differs from a standard structure or if the organization being audited is a smaller organization, then the corresponding department in the organization may differ from the recommended department. For example, a smaller organization may not have a dedicated IT department and may instead have a sole employee who is responsible for IT matters. In this case, the mapping of the recommended department to the department in the organization will result in mapping the recommended department to the employee. As used herein, a department includes individual employees who are responsible for particular functions within an organization. This mapping can be performed manually, such as by presenting the recommended departments to a user and having them use the recommended departments as a guide to delegate the appropriate persons/departments within their own organization. Alternatively, the mapping can be performed automatically, based upon organizational information provided by the organization being audited. For example, an organization can provide information indicating the roles and responsibilities of various internal departments and these roles and responsibilities can be matched to typical roles and responsibilities associated with the recommended departments.

At step 803 the control data structure is linked to the at least one department in the organization. This linking can take a variety of forms. For example, the control data structure and a department data structure corresponding to the department can be grouped together within a larger data structure. The control data structure can also be transformed to point to the control data structure using a pointer variable or similar means. Additionally, the control data structure can optionally include a department variable which can be used to track departments which are responsible for producing the required artifacts for the control corresponding to that control data structure. This variable can be initialized to null and then populated with the department information (such as a department identifier) upon determination of the department designated to provide the required artifacts. In the case of multiple departments, this variable can be a linked list, a dynamic array, or some other appropriate data structure. A department data structure corresponding to the department can also use a wrapper to store any control data structures which are linked to the department. Many variations for linking are possible and these examples are not intended to be limiting.

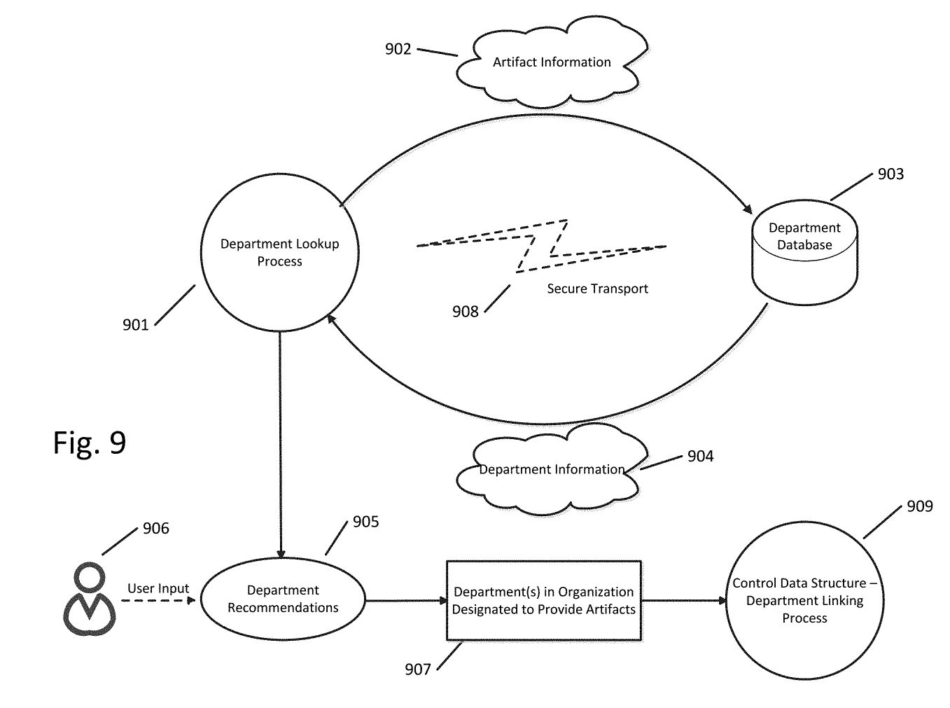

FIG. 9 illustrates an example of the department determination, mapping, and linking process according to an exemplary embodiment. As shown in FIG. 9, a department lookup process transmits a query 902 including artifact information to a department database 903. The department database 903 is configured to receive queries including artifact information (such as identifiers, descriptors, etc.) corresponding to artifacts and lookup and return department information corresponding to recommended departments to designate as being responsible for production of those artifacts. Department information corresponding to each department can be input to the department database 903 by subject matter experts or through automated means, such as scraping of relevant organization web sites and/or materials. Optionally, organization identifiers can be transmitted as part of the query 902 and used, along with the artifact information, to look up organization-specific department recommendations in the department database 903.

The department database 903 can optionally be access over a computer network 908 connecting computing devices at remote locations. Alternatively, the department database can be a local stored database. The database can take any form, such as a relational database, a lookup table, or a customized database.

In response to query 902, the department database 903 returns department information 904 which can include one or more department identifiers and/or department descriptors. If multiple departments could potentially be designated to provide an artifact, the department information 904 can include rankings of the departments.

The received department information 904 is used by the department lookup process 901 to generate department recommendations 905. These department recommendations 905 can be populated into an interface or form and optionally be presented to a user 906 for confirmation. Based upon user input or other organization-specific information which is gathered through data mining or web scraping, the department recommendations can then be mapped to organization-specific departments corresponding to the recommended departments (such as departments that have similar roles or responsibilities). These departments in the organization are then designated 907 to provide one or more of the artifacts that demonstrate compliance with a particular control corresponding to a control data structure. A control data structure-department linking process then links the department information (such as the department identifier, associated members/employees, managers, email lists, department descriptors) with the corresponding control data structure.

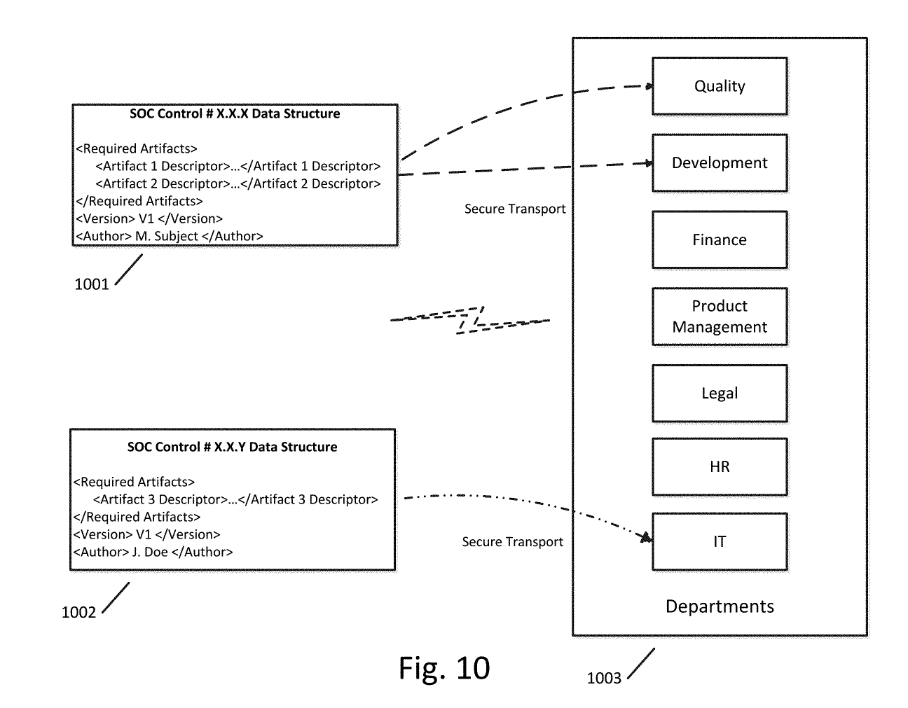

FIG. 10 illustrates an example of the linking between control data structures 1001 and 1002 and the departments of an organization 1003 according to an exemplary embodiment. As shown in FIG. 10, control data structure 1001 is linked to the quality department and the development department. In this case, the quality department could be designated to provide “Artifact 1” indicated by control data structure 1001 and the development department could be designated to provide “Artifact 2” indicated by control data structure. Similarly, control data structure 1002 is linked to the IT department, meaning that the IT department is designated to provide “Artifact 3.”

Returning to FIG. 1, at step 105 the one or more control data structures are stored in a secured folder structure. The secured folder structure is configured to provide access to each control data structure in the one or more control data structures to the at least one department linked to that control data structure. The secured folder structure is further configured to link each artifact uploaded to the secured folder structure with a corresponding control data structure in the one or more control data structures.

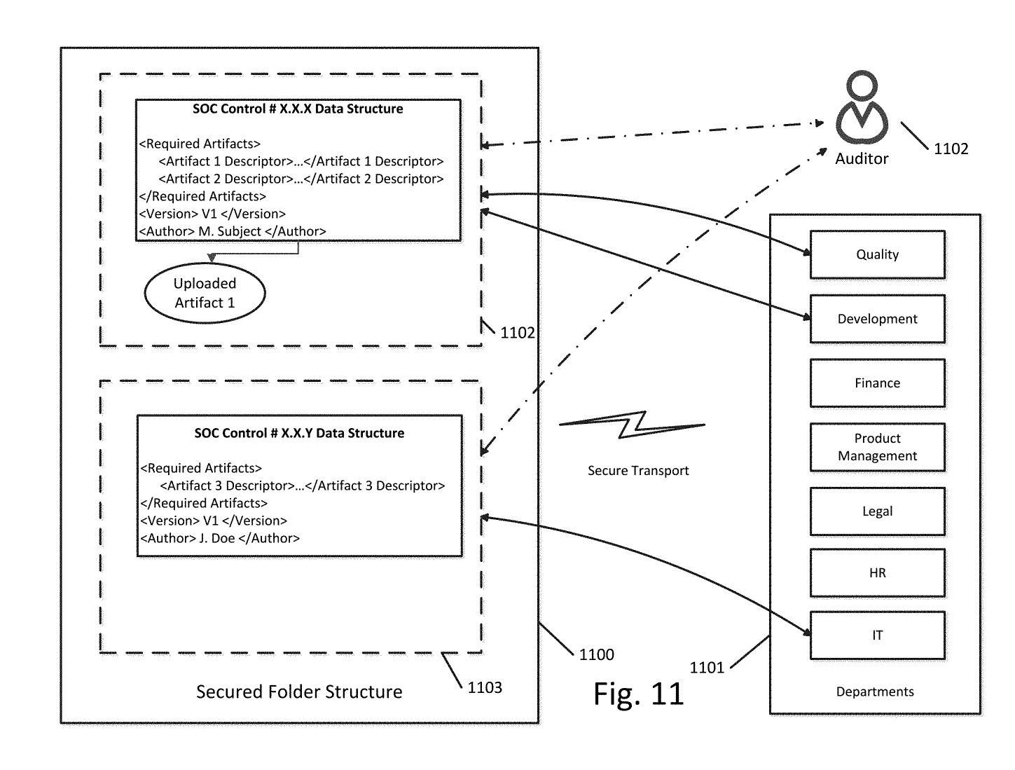

FIG. 11 illustrates an example of the secured folder structure according to an exemplary embodiment. The secured folder structure 1100 shown in FIG. 11 stores two control data structures 1102 and 1103. An uploaded artifact is also linked to control data structure 1102. This indicates that a user in one of the two departments (Quality or Development) in the departments of the organization 1101 linked to control data structure 1102 has uploaded an artifact to demonstrate compliance with the corresponding control. Both of the control data structures are accessible to their respective linked departments. Control data structure 1102 is accessible to its two linked departments, the quality department and the development department. Similarly, control data structure 1103 is accessible to its linked department, the IT department. As shown in the figure, access to the control data structure can include access to any artifacts linked to the control data structure, which are also stored in the secured folder structure. Access to the secured folder structure and specific control data structures within the secured folder structure can be restricted in a variety of ways. Authentication, passwords, and/or permissions can be used to restrict access to the secured folder structure and specific control data structures to employees within a certain department linked to those control data structures. A project manager or auditor 1102 can be granted access to the secured folder structure and control data structures and artifacts within the secured folder structure in order to oversee and conduct the audit. Additionally, the secured folder structure, or folders within it, can be encrypted and protected using additional access control mechanisms. This ensures security and confidentiality of audit information and uploaded artifact information. The relevant permissions and passwords can be provided to auditor 1102 and to the linked departments (including relevant employees) to provide access to the secured folder structure. Alternatively, permissions can be structured so that only employees who are registered with departments that are linked to certain control data structures are able to view or access those control data structures within the secured folder structure. Access can also be divided into various rights and permissions, depending on the particular department or employee. For example, some employees within a department can have read-only privileges whereas others can have read-write access.

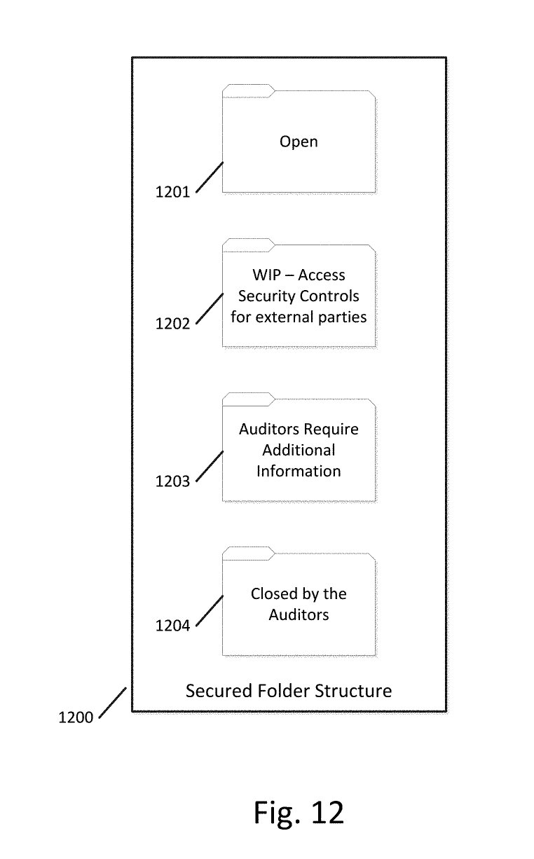

The secured folder structure can be comprised of a plurality of secured folders. FIG. 12 illustrates a secured folder structure 1200 comprising four distinct secured folders according to an exemplary embodiment. Open folder 1201 can be used to store control data structures corresponding to controls that have not yet been worked upon, have not been accessed, or are otherwise unmodified. Work-In-Progress (WIP) folder 1202 can be used to store control data structures that have been accessed or that have otherwise been modified. For example, the WIP folder can store a control data structure for which users have uploaded artifacts and the corresponding uploaded artifacts. Additional Information folder 1203 can be used to store control data structures that have been reviewed by auditors and subsequently rejected. These control data structures are those in which auditors typically require additional information to determine compliance. For example, a particular uploaded artifact may be rejected by an auditor, requiring a replacement artifact to demonstrate compliance with a particular control. Additional Information folder 1203 can also store linked artifacts that have been accepted by auditors. Closed folder 1204 can be used to store control data structures and linked artifacts that have been reviewed by auditors and accepted, thereby demonstrating compliance with the corresponding control. As discussed further below, automated actions or notifications can be associated with each of these secured folders, so that when a control data structure is added to a particular folder, the relevant personnel are notified regarding their responsibilities and next steps.

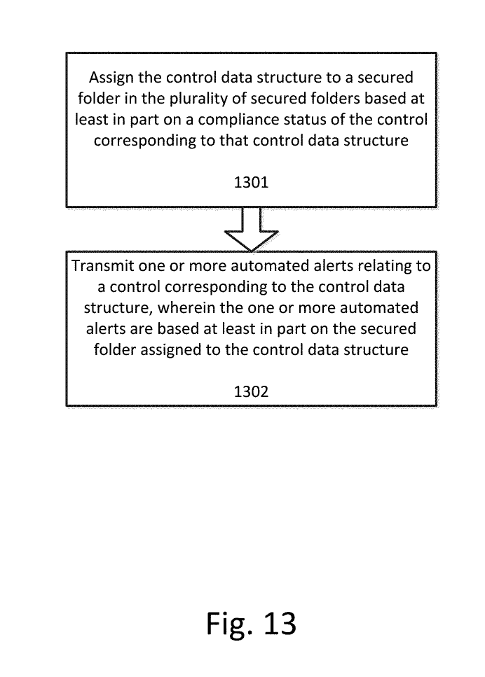

FIG. 13 illustrates a flowchart for storing a control data structure in a secured folder structure comprising a plurality of secured folders according to an exemplary embodiment. At step 1301 the control data structure is assigned to a secured folder in the plurality of secured folders based at least in part on a compliance status of the control corresponding to that control data structure.

Compliance status can be divided into multiple levels, such as ones that correspond to the secured folders shown in FIG. 12. In this case, the compliance status can indicate one of: Open, WIP, Additional Information Required, or Closed. Initially, all new control data structures would be assigned to the Open folder 1201. Upon user access or activity relating to a control data structure, it would be moved into the WIP folder 1202. Upon rejection by an auditor, the control data structure and any non-rejected uploaded artifacts linked to that control data structure would be moved into the Additional Information folder 1203. Upon acceptance of uploaded artifacts linked to a control data structure, it would be moved (along with the linked uploaded artifacts) to the Closed folder 1204.

At step 1302 of FIG. 13 one or more automated alerts relating to a control corresponding to the control data structure are transmitted. The one or more automated alerts are based at least in part on the secured folder assigned to the control data structure. Using the above example of FIG. 12, the addition of a control data structure to the Open folder 1201 can result in the transmission of initial messages to department stakeholders and employees within the department responsible for production of the artifacts that demonstrate compliance with the control and/or the transmission of password or authentication information required to access the secured folders. Similar, the addition or presence of a control data structure within the WIP folder 1202 can result in transmission of messages or status updates to relevant parties and project managers. The placement of a control data structure in the Additional Information folder 1203 can trigger notifications to project managers and employees or departments responsible for artifact production indicating the rejection. The placement of a control data structure in the Closed folder 1204 can trigger notifications to project managers and employees or departments responsible for artifact production indicating the acceptance. Any of these secured folders can have associated access controls or passwords which are transmitted to authorized parties responsible for artifact production when a control data structure is added to the respective secured folder.

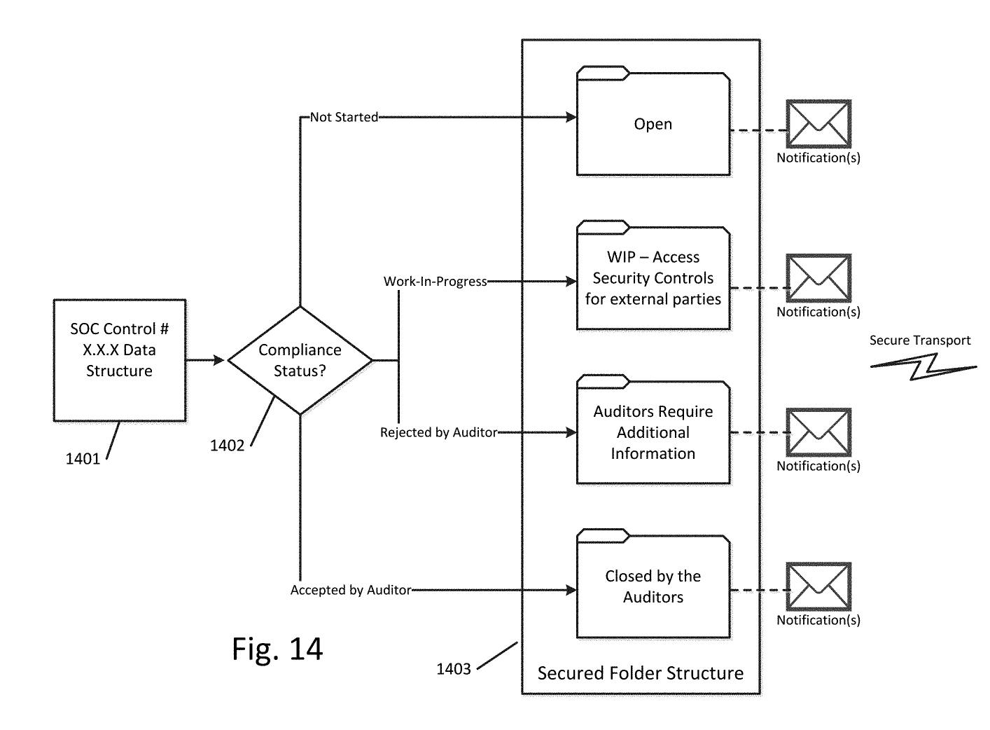

FIG. 14 illustrates an example of storing a control data structure in a secured folder structure comprising a plurality of secured folders according to an exemplary embodiment. As shown in FIG. 14, the compliance status of a control data structure 1401 is checked at decision block 1402. Depending on the compliance status, the control data structure is routed to the appropriate secured folder in the secured folder structure 1403. As shown in FIG. 14, each of the secured folders has associated notifications and/or alerts that are transmitted pertaining to the control data structures stored therein.

Returning to FIG. 1, at step 106 a notification is transmitted to an auditor associated with the audit based at least in part on a determination that one or more uploaded artifacts linked to at least one control data structure in the one or more control data structures correspond to one or more artifacts indicated by the at least one control data structure.

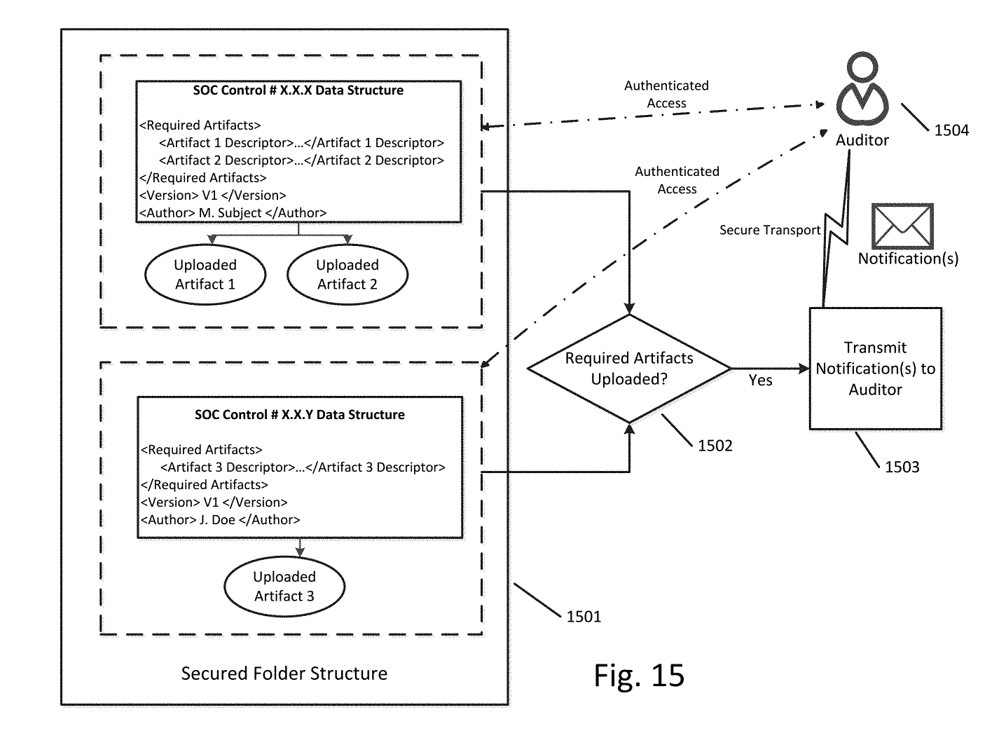

FIG. 15 illustrates an example of transmitting a notification to an auditor according to an exemplary embodiment. As shown in FIG. 15, secured folder structure includes two control data structures, each of which have linked uploaded artifacts. At decision block 1502, which can be a monitoring process that monitors secured folder structure, an assessment is made regarding whether the required artifacts for a particular control data structure have been uploaded. This assessment can be made, for example, by comparing descriptors or identifiers associated with uploaded artifacts linked to a particular control data structure with the artifact descriptors or identifiers indicated by the control data structure itself. If this assessment results in a determination that the required artifacts have been uploaded for any of the control data structures, this finding can optionally be transmitted to a project manager for review prior to alerting an auditor. Otherwise, at step 1503 a notification is transmitted to the auditor 1504 indicating which controls are ready for review. This notification can optionally include access information for accessing the secured folder structure 1501, identification information for the relevant control data structure and/or any linked artifacts. The auditor 1504 can then utilize the authenticated access to review the relevant control data structures and linked artifacts. After review, the auditor 1504 can either accept the provided artifacts as demonstrating compliance or reject them indicating non-compliance or additional evidence required. The feedback from the auditor 1504 can be received in a variety of ways, such as through messaging, input into an interface or automated form, or other communication means. In the case of an online form, the auditor can have the option to provide written feedback, such as why a particular linked artifact is not acceptable. When the secured folder structure comprises a plurality of secured folders, the acceptance or rejection in the feedback from the auditor can then be used to reclassify the submitted control data structures and linked artifacts into different secured folders.

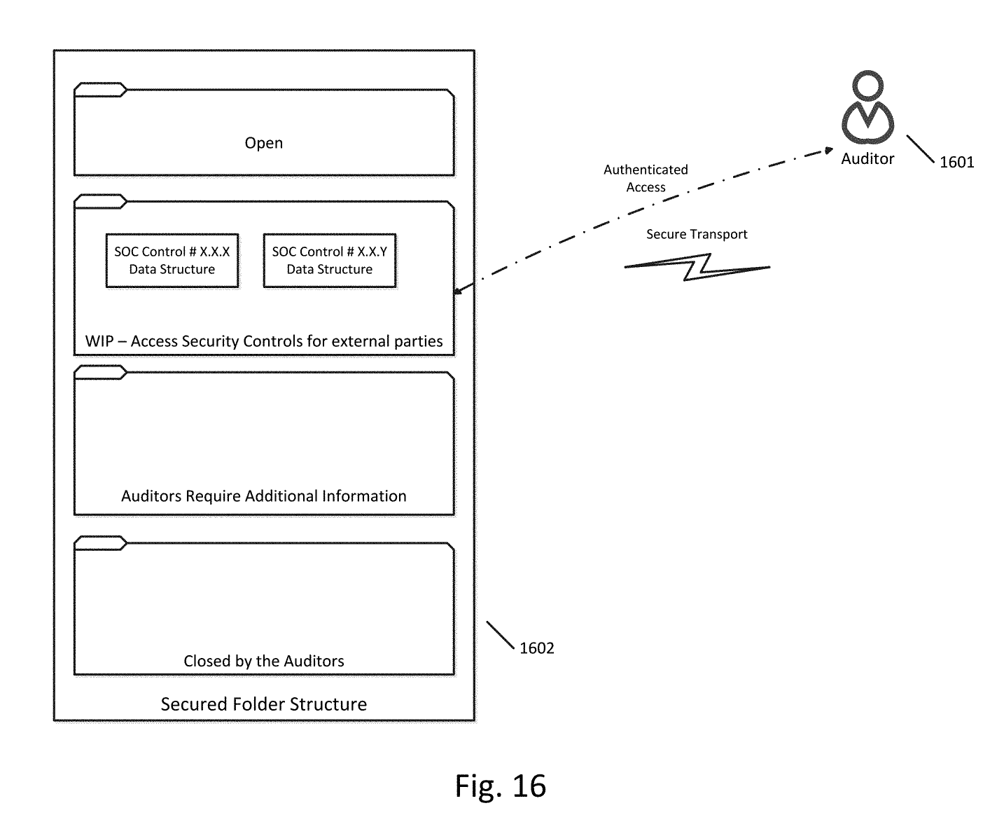

FIG. 16 illustrates a secured folder structure 1602 comprising a plurality of secured folders in which the auditor 1601 has authenticated access to one of those folders according to an exemplary embodiment. In this case, the auditor 1601 is able to access the WIP folder in order to review control data structures stored therein and any linked artifacts. Although linked artifacts are not shown in the figure, they would also be stored in the WIP folder along with their linked control data structures. Optionally, the auditor can also have access to the Additional Information folder so that the auditor can review previously rejected control and linked artifacts.

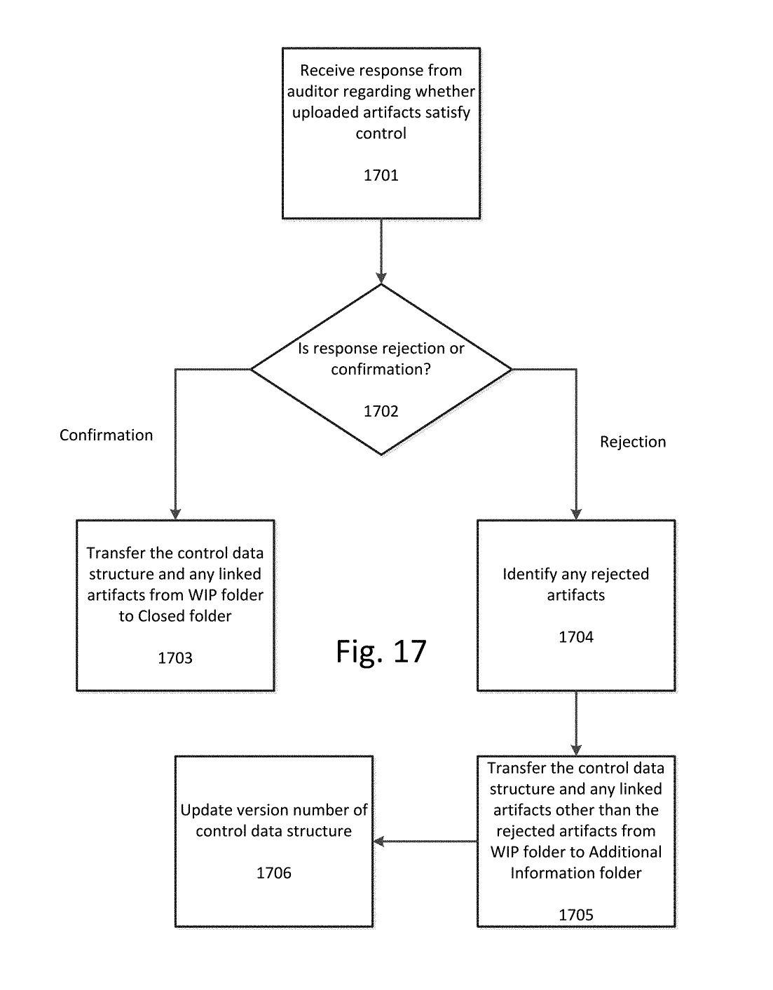

FIG. 17 illustrates a flowchart for transitioning a control data structure and uploaded artifacts linked to that control data structure that are stored in the WIP folder to a different secured folder based on a response from an auditor according to an exemplary embodiment. The steps in this flowchart would occur after a notification is transmitted to the auditor indicating that the control data structure and uploaded artifacts linked to the control data structure are ready for review and after the auditor had reviewed the control data structure and uploaded artifacts linked to the control data structure.

At step 1701 a response is received from the auditor regarding whether the uploaded artifacts linked to the control data structure satisfy the control corresponding to the control data structure. At step 1702 a determination is made regarding whether the response confirms that the uploaded artifacts demonstrate compliance or whether the response rejects one or more of the uploaded artifacts or requests additional evidence. If the response is a confirmation then at step 1703 the control data structure and uploaded artifacts linked to that control data structure is transferred from the WIP folder to the Closed folder. If the response is a rejection than any rejected uploaded artifacts are identified at step 1704. At step 1705 the control data structure and any uploaded artifacts linked to that control data structure other than the rejected artifacts are transferred from the WIP folder to the Additional Information folder. The rejected artifacts can optionally remain in the WIP folder or be automatically removed or deleted from storage. At step 1706 the version number of the control data structure is updated, such as by incrementing the version number, to indicate that the control data structure has previously been submitted and rejected. If the rejected artifacts remain in the WIP folder, then they can optionally continue to be linked to the prior version of the control data structure, for record keeping purposes.

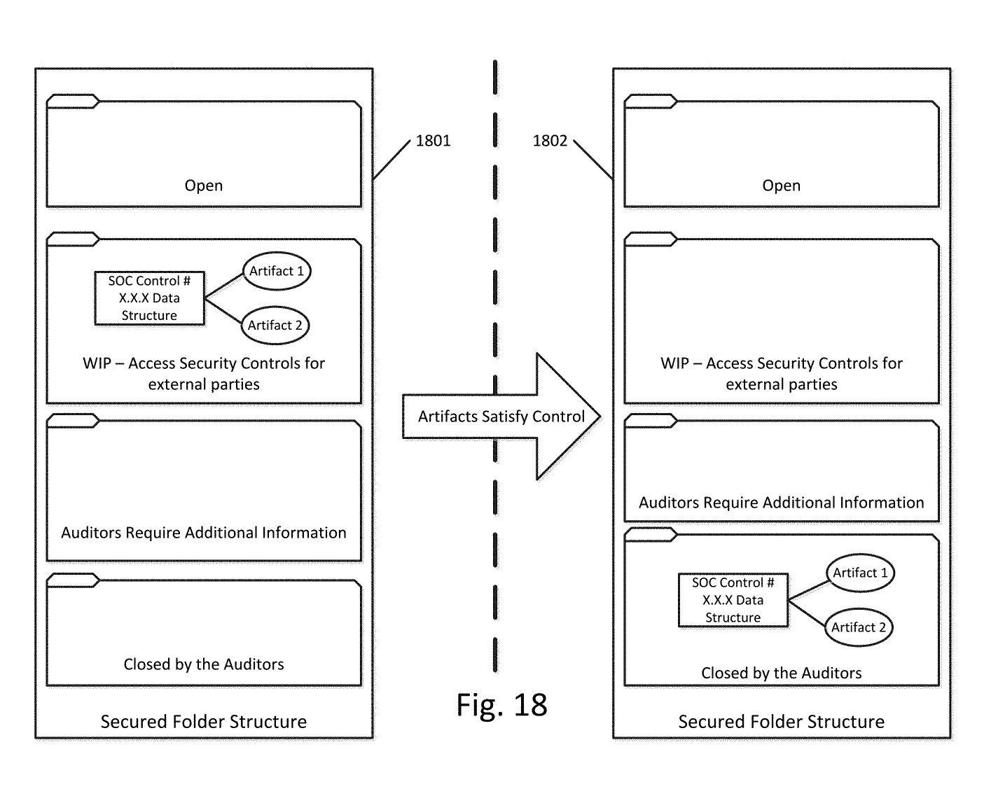

FIG. 18 illustrates an example of transitioning a control data structure and uploaded artifacts linked to that control data structure that are stored in the WIP folder to a different secured folder based on a response from an auditor according to an exemplary embodiment. As shown in FIG. 18, the auditor has deemed the uploaded artifacts linked to the control data structure in the WIP folder of secured folder structure 1801 to satisfy the corresponding control. Secured folder structure 1802 illustrates the transfer of data made in response to the confirmation made by the auditor. As shown in secured folder structure 1802, the control data structure and the uploaded artifacts linked to the control data structure have been transferred to the Closed folder.

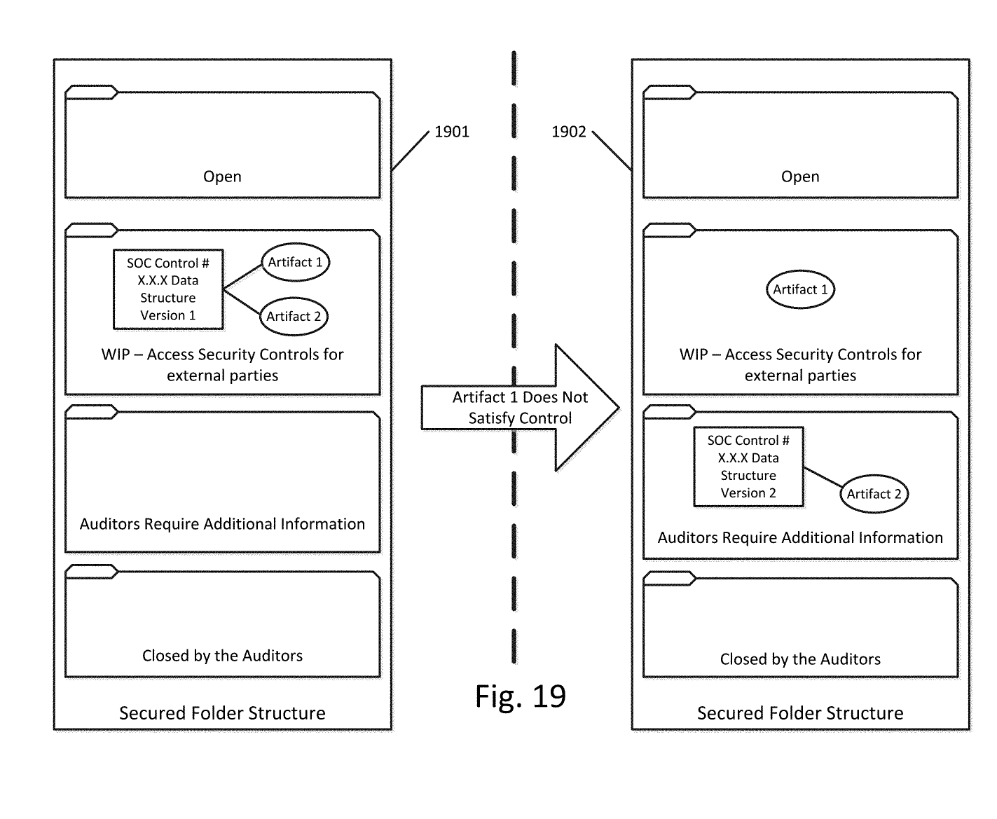

FIG. 19 illustrates another example of transitioning a control data structure and uploaded artifacts linked to that control data structure that are stored in the WIP folder to a different secured folder based on a response from an auditor according to an exemplary embodiment. As shown in FIG. 19, the auditor's response indicates that uploaded artifact 1 linked to the control data structure in the WIP folder of secured folder structure 1901 does not satisfy the corresponding control. Secured folder structure 1902 illustrates the transfer of data made in response to the rejection made by the auditor. As shown in secured folder structure 1902, the control data structure and the uploaded artifacts linked to the control data structure other than the rejected artifact 1 have been transferred to the Additional Information folder. Artifact 1 remains in the WIP folder and can optionally be deleted. Additionally, the version number of the control data structure in the Additional Information folder is updated to indicate this transaction.

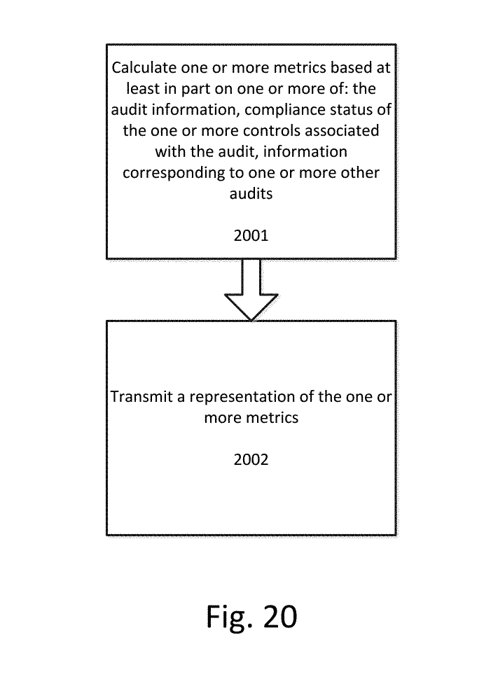

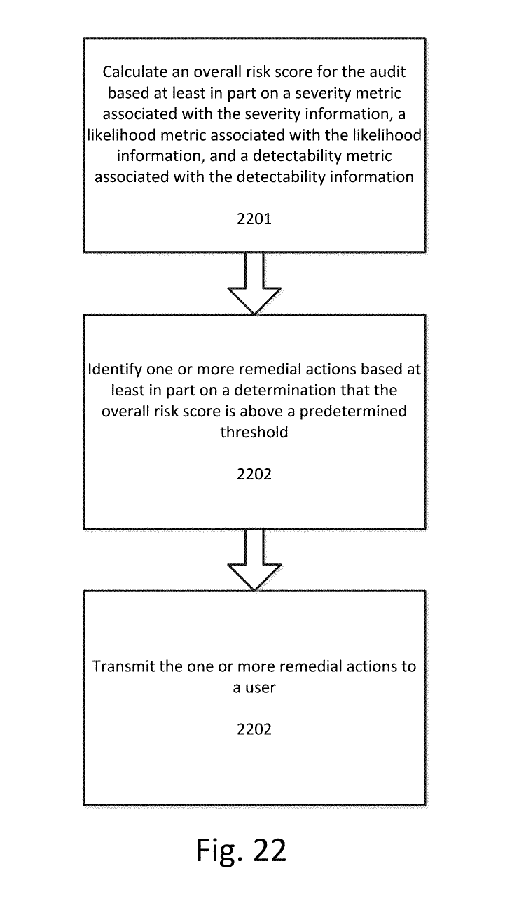

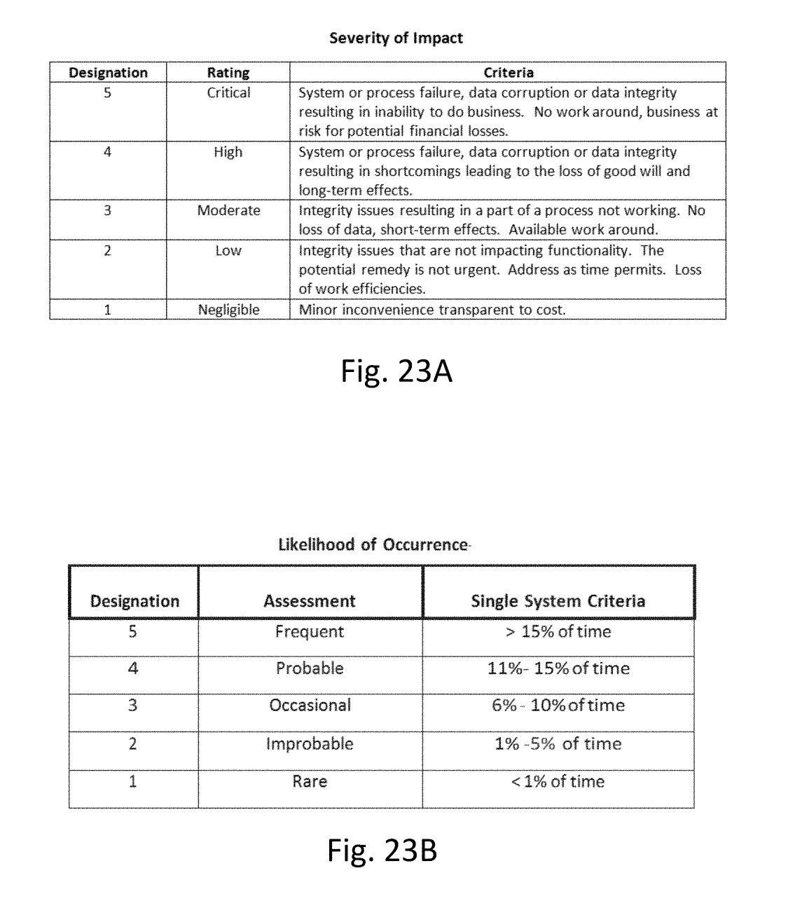

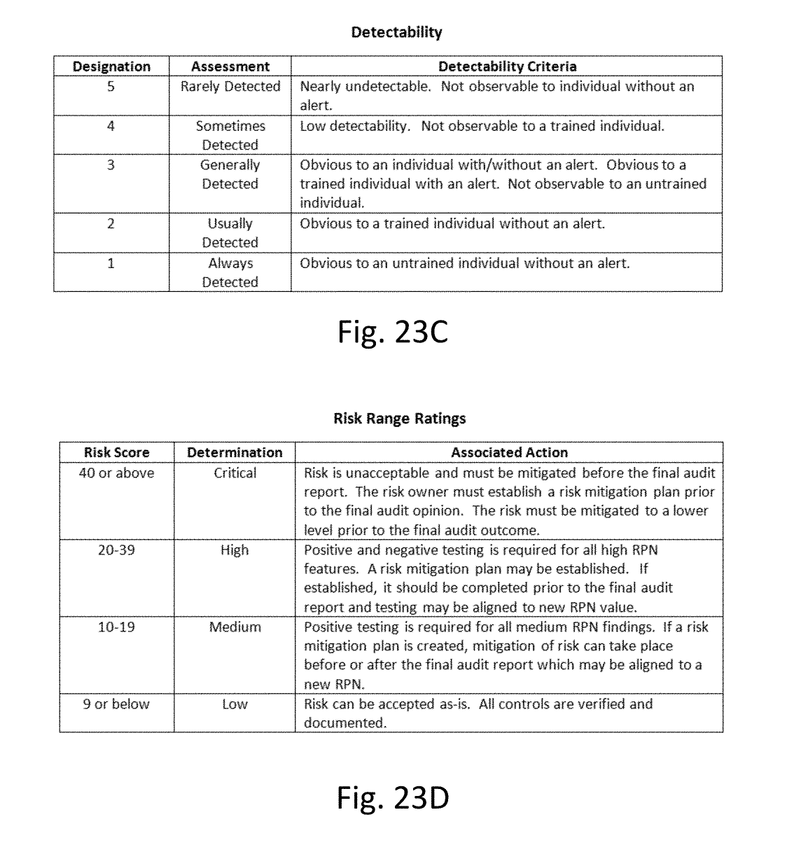

FIG. 20 illustrates a flowchart for calculating one or more metrics pertaining to one or more audits according to an exemplary embodiment. At step 2001 one or more metrics are calculated based at least in part on the audit information, compliance status of the one or more controls associated with the audit, and/or information corresponding to one or more other audits. As discussed below with respect to FIGS. 22-23D, these metrics can also be risk or severity metrics based upon risk measures or risk or severity related information.

At step 2002 a representation of the one or more metrics is transmitted. The representation can be transmitted to a user, such as a project manager, through a user interface. The representation can include charts, graphs, tables, reports, statistics, summaries, or any other type of representation. The representation can also be transmitted via electronic communication, such as emails, messages, chat, alerts, notifications, etc.

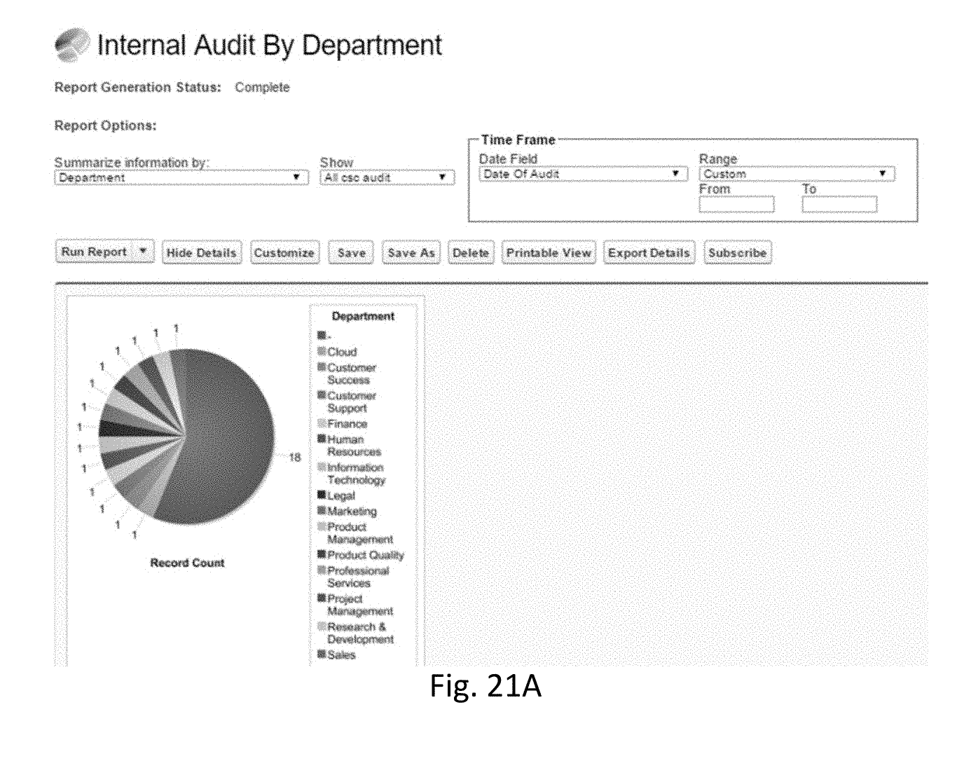

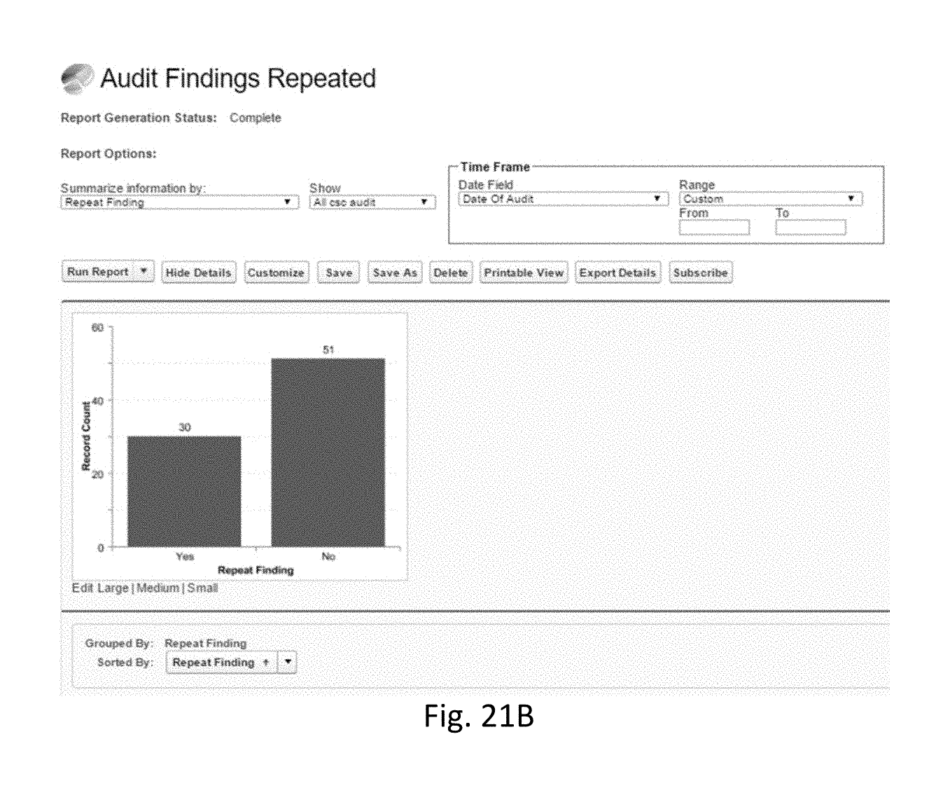

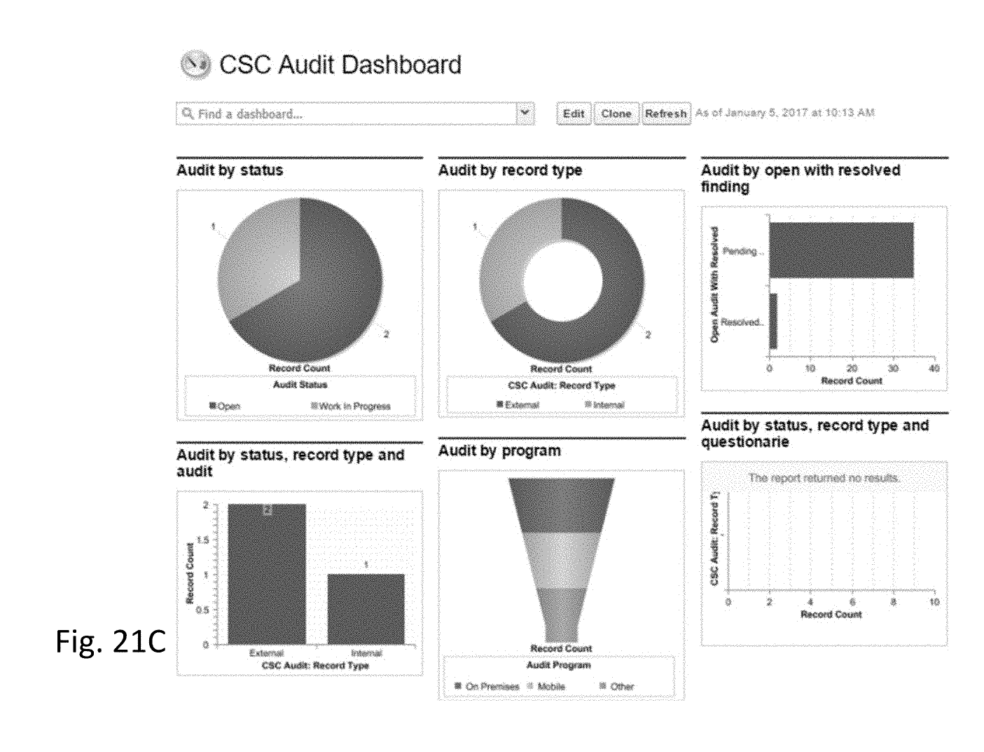

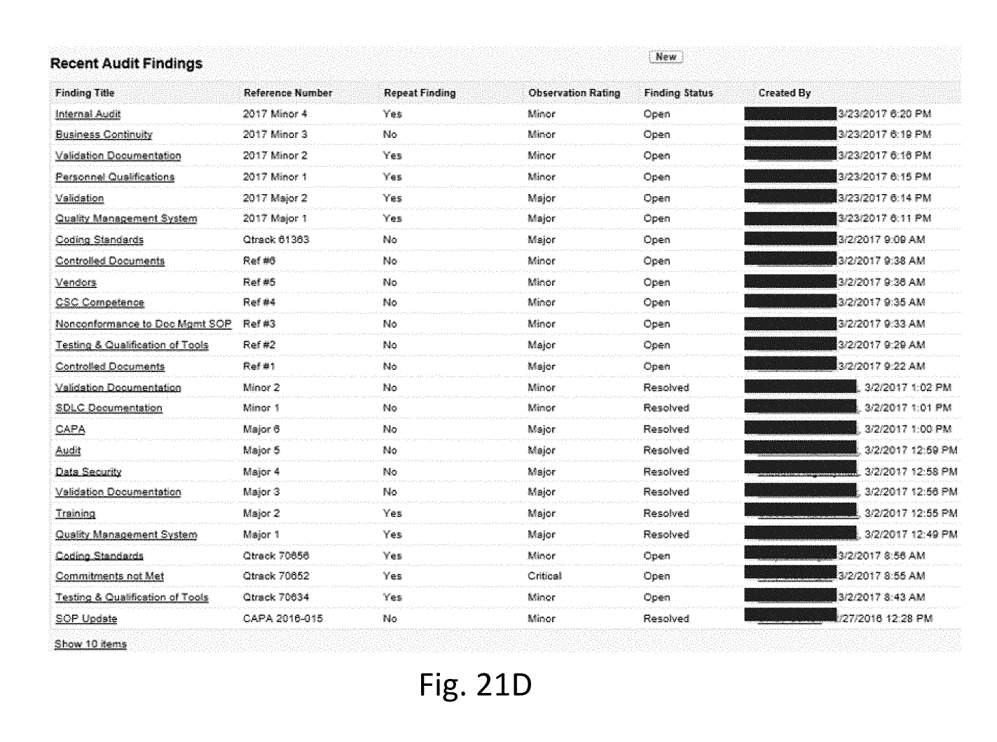

FIGS. 21A-21D illustrate representations of various metrics according to an exemplary embodiment. FIG. 21A illustrates a dashboard including a pie chart indicating the breakdown of internal audits by department. FIG. 21B illustrates a bar chart showing the relative number of audits in which audit findings were repeated. FIG. 21C illustrates various graphs and charts used to categorize audits according to different criteria, such as by status, record type, program, etc. FIG. 21D illustrates a table illustrating recent audit findings.

FIG. 22 illustrates a flowchart for recommending remedial actions based on a total risk score metric corresponding to an audit according to an exemplary embodiment. At step 2201 an overall risk score for an audit is calculated based at least in part on a severity metric associated with severity information indicating a severity of a risk, a likelihood metric associated with likelihood information indicating a likelihood of a risk, and a detectability metric associated with detectability information indicating a detectability of a risk. At step 2202 one or more remedial actions are identified based at least in part on a determination that the overall risk score is above a predetermined threshold. At step 2203 the one or more remedial actions are transmitted to a user.

The severity information, likelihood information, and detectability information can all be part of audit information received by the system and can be provided by a user in response to a questionnaire. This information can also be derived based upon an analysis of records or other audit information.

FIGS. 23A-23D illustrate tables used to calculate severity, likelihood, and detectability metrics, overall risk scores, and corresponding remedial actions according to an exemplary embodiment.

FIG. 23A illustrates severity criteria, severity ratings, and corresponding severity metrics (“designation”). A user can be presented with the severity criteria corresponding to the severity ratings and can select a severity rating based upon the criteria. The selected rating can then be mapped to the appropriate severity metric (from 1-5).

FIG. 23B illustrates likelihood criteria, likelihood assessments, and corresponding likelihood metrics (“designation”). A user can be presented with the likelihood criteria corresponding to likelihood assessments and can select a likelihood assessment based upon the likelihood criteria. The selected assessment can then be mapped to the appropriate likelihood metric (from 1-5).

FIG. 23C illustrates detectability criteria, detectability assessments, and corresponding detectability metrics (“designation”). A user can be presented with the detectability criteria corresponding to detectability assessments and can select a detectability assessment based upon the likelihood criteria. The selected assessment can then be mapped to the appropriate detectability metric (from 1-5).

Once the severity metric, likelihood metric, and detectability metric have been determined, a total risk score can be computed as:

Total Risk Score=Severity Metric×Likelihood Metric×Detectability Metric

FIG. 23D illustrates the various total risk score thresholds and the corresponding remedial actions for each risk score threshold. A total risk score that is deemed critical can result in automatic corrective actions being taken. Each of the corresponding remedial action can result in the transmission of the appropriate alerts and notification to the relevant parties.

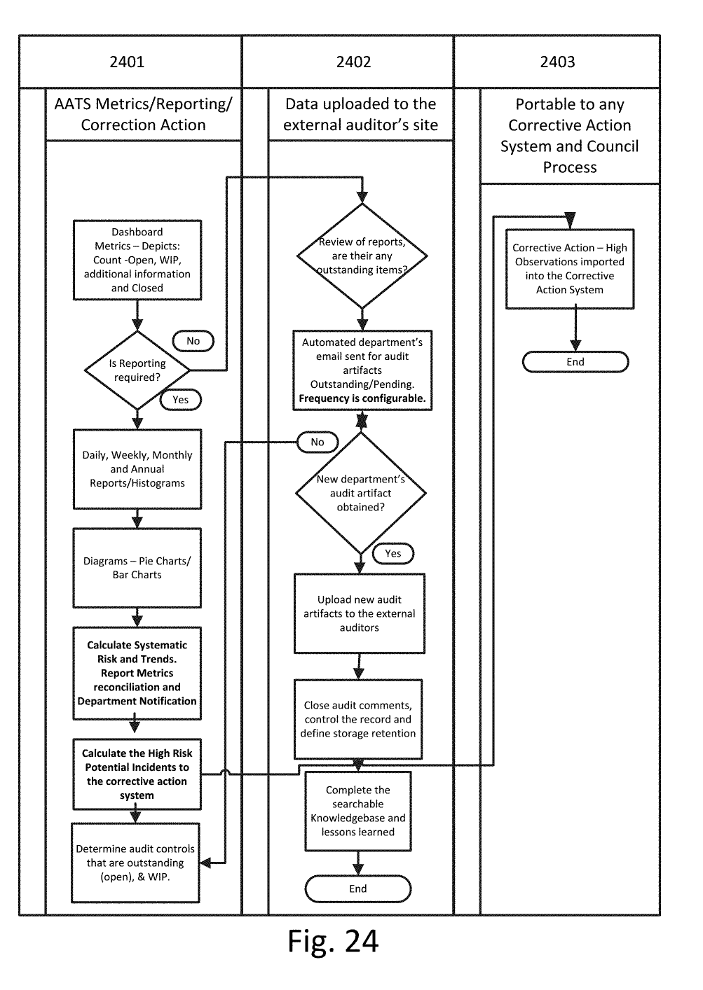

FIG. 24 illustrates a flowchart for determining metrics, reporting, and taking corrective actions according to an exemplary embodiment. Column 2401 enumerates the steps that can be performed when calculating metrics and displaying results, including calculation of risk and severity. Column 2402 enumerates steps than can be performed after data is uploaded to an external auditor. Additionally, column 2403 illustrates the corrective action step that is taken when high risk is detected.

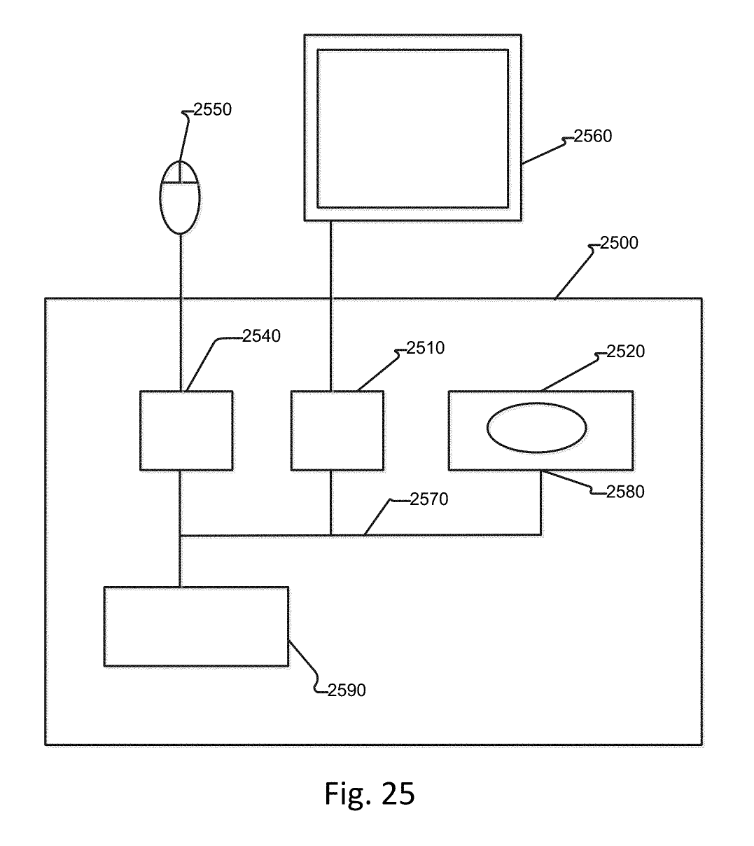

One or more of the above-described techniques can be implemented in or involve one or more computer systems. FIG. 25 illustrates an example of a computing environment 2500. The computing environment 2500 is not intended to suggest any limitation as to scope of use or functionality of a described embodiment(s).

With reference to FIG. 25, the computing environment 2500 includes at least one processing unit 2510 and memory 2520. The processing unit 2510 executes computer-executable instructions and can be a real or a virtual processor. In a multi-processing system, multiple processing units execute computer-executable instructions to increase processing power. The memory 2520 can be volatile memory (e.g., registers, cache, RAM), non-volatile memory (e.g., ROM, EEPROM, flash memory, etc.), or some combination of the two. The memory 2520 can store software 2580 implementing described techniques.

A computing environment can have additional features. For example, the computing environment 2500 includes storage 2540, one or more input devices 2550, one or more output devices 2560, and one or more communication connections 2590. An interconnection mechanism 2570, such as a bus, controller, or network interconnects the components of the computing environment 2500. Typically, operating system software or firmware (not shown) provides an operating environment for other software executing in the computing environment 2500, and coordinates activities of the components of the computing environment 2500.

The storage 2540 can be removable or non-removable, and includes magnetic disks, magnetic tapes or cassettes, CD-ROMs, CD-RWs, DVDs, or any other medium which can be used to store information and which can be accessed within the computing environment 2500. The storage 2540 can store instructions for the software 2580.

The input device(s) 2550 can be a touch input device such as a keyboard, mouse, pen, trackball, touch screen, or game controller, a voice input device, a scanning device, a digital camera, remote control, or another device that provides input to the computing environment 2500. The output device(s) 2560 can be a display, television, monitor, printer, speaker, or another device that provides output from the computing environment 2500.

The communication connection(s) 2590 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the context of computer-readable media. Computer-readable media are any available media that can be accessed within a computing environment. By way of example, and not limitation, within the computing environment 2500, computer-readable media include memory 2520, storage 2540, communication media, and combinations of any of the above.

Of course, FIG. 25 illustrates computing environment 2500, display device 2560, and input device 2550 as separate devices for ease of identification only. Computing environment 2500, display device 2560, and input device 2550 can be separate devices (e.g., a personal computer connected by wires to a monitor and mouse), can be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 2500 can be a set-top box, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

We claim:

1. A method executed by one or more computing devices for artifact tracking, the method comprising:
receiving, by at least one of the one or more computing devices, audit information corresponding to an audit;
determining, by at least one of the one or more computing devices, for each control in one or more controls associated with the audit, one or more artifacts necessary for compliance with the control based at least in part on control information associated with the control and the audit information corresponding to the audit;
generating, by at least one of the one or more computing devices, one or more control data structures corresponding to the one or more controls, each control data structure indicating the one or more artifacts necessary for compliance with a corresponding control in the one or more controls;
linking, by at least one of the one or more computing devices, the one or more control data structures to one or more departments in an organization, each control data structure being linked to at least one department in the one or more departments that is designated to provide the one or more artifacts indicated by that control data structure;
storing, by at least one of the one or more computing devices, the one or more control data structures in a secured folder structure, wherein the secured folder structure is configured to provide access to each control data structure in the one or more control data structures to the at least one department linked to that control data structure and further configured to link each artifact uploaded to the secured folder structure with a corresponding control data structure in the one or more control data structures; and
transmitting, by at least one of the one or more computing devices, a notification to an auditor associated with the audit based at least in part on a determination that one or more uploaded artifacts linked to at least one control data structure in the one or more control data structures correspond to one or more artifacts indicated by the at least one control data structure.

2. The method of claim 1, wherein the audit information comprises one or more of: an audit type, an audit template, a control number corresponding to a control, artifact information corresponding to a control, an audit owner, an audit department, a control data structure identifier, or a control data structure version number.

3. The method of claim 1, wherein determining, for each control in one or more controls associated with the audit, one or more artifacts necessary for compliance with the control based at least in part on control information associated with the control and the audit information corresponding to the audit comprises, for each control in the one or more controls:
determining a control identifier corresponding to the control;
querying a database with the control identifier and an audit identifier corresponding to the audit to retrieve one or more artifact identifiers corresponding to the one or more artifacts necessary for compliance with the control.

4. The method of claim 3, wherein the audit information comprises information indicating one or more of a risk level or a severity level associated with the audit and wherein determining, for each control in one or more controls associated with the audit, one or more artifacts necessary for compliance with the control based at least in part on control information associated with the control and the audit information corresponding to the audit further comprises, for each control in the one or more controls:
determining a time period for compliance with the control based at least in part on one or more of the risk level or the severity level associated with the audit.

5. The method of claim 1, wherein linking the one or more control data structures to one or more departments in an organization comprises, for each control data structure in the one or more control data structures:
querying a database with one or more artifact identifiers corresponding to the one or more artifacts necessary for compliance with the control corresponding to the control data structure to retrieve at least one recommended department;
mapping the at least one recommended department to at least one department in the organization; and
linking the control data structure to the at least one department in the organization.

6. The method of claim 1, wherein the secured folder structure comprises a plurality of secured folders and wherein storing the one or more control data structures in a secured folder structure comprises, for each control data structure in the one or more control data structures:
assigning the control data structure to a secured folder in the plurality of secured folders based at least in part on a compliance status of the control corresponding to that control data structure; and
transmitting one or more automated alerts relating to a control corresponding to the control data structure, wherein the one or more automated alerts are based at least in part on the secured folder assigned to the control data structure.

7. The method of claim 1, wherein the at least one control data structure and the one or more uploaded artifacts linked to the at least one control data structure are stored in a first secured folder in a plurality of secured folders of the secured folder structure, and wherein the secured folder structure is configured to provide the auditor authenticated access to the first secured folder.

8. The method of claim 7, further comprising:
receiving, by at least one of the one or more computing devices, a confirmation from the auditor indicating that the one or more uploaded artifacts satisfy at least one control corresponding to the at least one control data structure; and
transferring, by at least one of the one or more computing devices, the at least one control data structure and the one or more uploaded artifacts from the first secured folder to a second secured folder in the plurality of secured folders based at least in part on the received confirmation.

9. The method of claim 7, further comprising:
receiving, by at least one of the one or more computing devices, a rejection from the auditor indicating that at least one uploaded artifact in the one or more uploaded artifacts does not satisfy at least one control corresponding to the at least one control data structure; and
transferring, by at least one of the one or more computing devices, the at least one control data structure and the one or more uploaded artifacts other than the at least one uploaded artifact that does not satisfy the at least one control from the first secured folder to a second secured folder in the plurality of secured folders based at least in part on the received rejection; and
updating, by at least one of the one or more computing devices, a version number associated with the at least one control data structure.

10. The method of claim 1, further comprising:
calculating, by at least one of the one or more computing devices, one or more metrics based at least in part on one or more of: the audit information, compliance status of the one or more controls associated with the audit, information corresponding to one or more other audits; and
transmitting, by at least one of the one or more computing devices, a representation of the one or more metrics.

11. The method of claim 10, wherein the audit information comprises severity information associated with a severity of risk, likelihood information associated with a likelihood of a risk, and detectability information associated with detectability of a risk and wherein calculating one or more metrics comprises:
calculating an overall risk score for the audit based at least in part on a severity metric associated with the severity information, a likelihood metric associated with the likelihood information, and a detectability metric associated with the detectability information.

12. The method of claim 11, further comprising:
identifying, by at least one of the one or more computing devices, one or more remedial actions based at least in part on a determination that the overall risk score is above a predetermined threshold; and
transmitting, by at least one of the one or more computing devices, the one or more remedial actions to a user.

13. An apparatus for artifact tracking, the apparatus comprising:
one or more processors; and
one or more memories operatively coupled to at least one of the one or more processors and having instructions stored thereon that, when executed by at least one of the one or more processors, cause at least one of the one or more processors to:
receive audit information corresponding to an audit;
determine, for each control in one or more controls associated with the audit, one or more artifacts necessary for compliance with the control based at least in part on control information associated with the control and the audit information corresponding to the audit;
generate one or more control data structures corresponding to the one or more controls, each control data structure indicating the one or more artifacts necessary for compliance with a corresponding control in the one or more controls;
link the one or more control data structures to one or more departments in an organization, each control data structure being linked to at least one department in the one or more departments that is designated to provide the one or more artifacts indicated by that control data structure;
store the one or more control data structures in a secured folder structure, wherein the secured folder structure is configured to provide access to each control data structure in the one or more control data structures to the at least one department linked to that control data structure and further configured to link each artifact uploaded to the secured folder structure with a corresponding control data structure in the one or more control data structures; and
transmit a notification to an auditor associated with the audit based at least in part on a determination that one or more uploaded artifacts linked to at least one control data structure in the one or more control data structures correspond to one or more artifacts indicated by the at least one control data structure.

14. The apparatus of claim 13, wherein the audit information comprises one or more of: an audit type, an audit template, a control number corresponding to a control, artifact information corresponding to a control, an audit owner, an audit department, a control data structure identifier, or a control data structure version number.

15. The apparatus of claim 13, wherein the instructions that, when executed by at least one of the one or more processors, cause at least one of the one or more processors to determine, for each control in one or more controls associated with the audit, one or more artifacts necessary for compliance with the control based at least in part on control information associated with the control and the audit information corresponding to the audit further cause at least one of the one or more processors to, for each control in the one or more controls:
determine a control identifier corresponding to the control;
query a database with the control identifier and an audit identifier corresponding to the audit to retrieve one or more artifact identifiers corresponding to the one or more artifacts necessary for compliance with the control.

16. The apparatus of claim 15, wherein the audit information comprises information indicating one or more of a risk level or a severity level associated with the audit and wherein the instructions that, when executed by at least one of the one or more processors, cause at least one of the one or more processors to determine, for each control in one or more controls associated with the audit, one or more artifacts necessary for compliance with the control based at least in part on control information associated with the control and the audit information corresponding to the audit further cause at least one of the one or more processors to, for each control in the one or more controls:
determine a time period for compliance with the control based at least in part on one or more of the risk level or the severity level associated with the audit.

17. The apparatus of claim 13, wherein the instructions that, when executed by at least one of the one or more processors, cause at least one of the one or more processors to link the one or more control data structures to one or more departments in an organization further cause at least one of the one or more processors to, for each control data structure in the one or more control data structures:
query a database with one or more artifact identifiers corresponding to the one or more artifacts necessary for compliance with the control corresponding to the control data structure to retrieve at least one recommended department;
map the at least one recommended department to at least one department in the organization; and
link the control data structure to the at least one department in the organization.

18. The apparatus of claim 13, wherein the secured folder structure comprises a plurality of secured folders and wherein the instructions that, when executed by at least one of the one or more processors, cause at least one of the one or more processors to store the one or more control data structures in a secured folder structure further cause at least one of the one or more processors to, for each control data structure in the one or more control data structures:
assign the control data structure to a secured folder in the plurality of secured folders based at least in part on a compliance status of the control corresponding to that control data structure; and
transmit one or more automated alerts relating to a control corresponding to the control data structure, wherein the one or more automated alerts are based at least in part on the secured folder assigned to the control data structure.

19. The apparatus of claim 13, wherein the at least one control data structure and the one or more uploaded artifacts linked to the at least one control data structure are stored in a first secured folder in a plurality of secured folders of the secured folder structure, and wherein the secured folder structure is configured to provide the auditor authenticated access to the first secured folder.

20. The apparatus of claim 19, wherein at least one of the one or more memories has further instructions stored thereon that, when executed by at least one of the one or more processors, cause at least one of the one or more processors to:
receive a confirmation from the auditor indicating that the one or more uploaded artifacts satisfy at least one control corresponding to the at least one control data structure; and
transfer the at least one control data structure and the one or more uploaded artifacts from the first secured folder to a second secured folder in the plurality of secured folders based at least in part on the received confirmation.

21. The apparatus of claim 19, wherein at least one of the one or more memories has further instructions stored thereon that, when executed by at least one of the one or more processors, cause at least one of the one or more processors to:
receive a rejection from the auditor indicating that at least one uploaded artifact in the one or more uploaded artifacts does not satisfy at least one control corresponding to the at least one control data structure; and
transfer the at least one control data structure and the one or more uploaded artifacts other than the at least one uploaded artifact that does not satisfy the at least one control from the first secured folder to a second secured folder in the plurality of secured folders based at least in part on the received rejection; and
update a version number associated with the at least one control data structure.

22. The apparatus of claim 13, wherein at least one of the one or more memories has further instructions stored thereon that, when executed by at least one of the one or more processors, cause at least one of the one or more processors to:
calculate one or more metrics based at least in part on one or more of: the audit information, compliance status of the one or more controls associated with the audit, information corresponding to one or more other audits; and
transmit a representation of the one or more metrics.

23. The apparatus of claim 22, wherein the audit information comprises severity information associated with a severity of risk, likelihood information associated with a likelihood of a risk, and detectability information associated with detectability of a risk and wherein the instructions that, when executed by at least one of the one or more processors, cause at least one of the one or more processors to calculate one or more metrics further cause at least one of the one or more processors to:
calculate an overall risk score for the audit based at least in part on a severity metric associated with the severity information, a likelihood metric associated with the likelihood information, and a detectability metric associated with the detectability information.

24. The apparatus of claim 23, wherein at least one of the one or more memories has further instructions stored thereon that, when executed by at least one of the one or more processors, cause at least one of the one or more processors to:
identify one or more remedial actions based at least in part on a determination that the overall risk score is above a predetermined threshold; and
transmit the one or more remedial actions to a user.

25. At least one non-transitory computer-readable medium storing computer-readable instructions that, when executed by one or more computing devices, cause at least one of the one or more computing devices to:
receive audit information corresponding to an audit;
determine, for each control in one or more controls associated with the audit, one or more artifacts necessary for compliance with the control based at least in part on control information associated with the control and the audit information corresponding to the audit;
generate one or more control data structures corresponding to the one or more controls, each control data structure indicating the one or more artifacts necessary for compliance with a corresponding control in the one or more controls;
link the one or more control data structures to one or more departments in an organization, each control data structure being linked to at least one department in the one or more departments that is designated to provide the one or more artifacts indicated by that control data structure;
store the one or more control data structures in a secured folder structure, wherein the secured folder structure is configured to provide access to each control data structure in the one or more control data structures to the at least one department linked to that control data structure and further configured to link each artifact uploaded to the secured folder structure with a corresponding control data structure in the one or more control data structures; and
transmit a notification to an auditor associated with the audit based at least in part on a determination that one or more uploaded artifacts linked to at least one control data structure in the one or more control data structures correspond to one or more artifacts indicated by the at least one control data structure.

26. The at least one non-transitory computer-readable medium of claim 25, wherein the audit information comprises one or more of: an audit type, an audit template, a control number corresponding to a control, artifact information corresponding to a control, an audit owner, an audit department, a control data structure identifier, or a control data structure version number.

27. The at least one non-transitory computer-readable medium of claim 25, wherein the instructions that, when executed by at least one of the one or more computing devices, cause at least one of the one or more computing devices to determine, for each control in one or more controls associated with the audit, one or more artifacts necessary for compliance with the control based at least in part on control information associated with the control and the audit information corresponding to the audit further cause at least one of the one or more computing devices to, for each control in the one or more controls:
determine a control identifier corresponding to the control;
query a database with the control identifier and an audit identifier corresponding to the audit to retrieve one or more artifact identifiers corresponding to the one or more artifacts necessary for compliance with the control.

28. The at least one non-transitory computer-readable medium of claim 27, wherein the audit information comprises information indicating one or more of a risk level or a severity level associated with the audit and wherein the instructions that, when executed by at least one of the one or more computing devices, cause at least one of the one or more computing devices to determine, for each control in one or more controls associated with the audit, one or more artifacts necessary for compliance with the control based at least in part on control information associated with the control and the audit information corresponding to the audit further cause at least one of the one or more computing devices to, for each control in the one or more controls:
determine a time period for compliance with the control based at least in part on one or more of the risk level or the severity level associated with the audit.

29. The at least one non-transitory computer-readable medium of claim 25, wherein the instructions that, when executed by at least one of the one or more computing devices, cause at least one of the one or more computing devices to link the one or more control data structures to one or more departments in an organization further cause at least one of the one or more computing devices to, for each control data structure in the one or more control data structures:
query a database with one or more artifact identifiers corresponding to the one or more artifacts necessary for compliance with the control corresponding to the control data structure to retrieve at least one recommended department;
map the at least one recommended department to at least one department in the organization; and
link the control data structure to the at least one department in the organization.

30. The at least one non-transitory computer-readable medium of claim 25, wherein the secured folder structure comprises a plurality of secured folders and wherein the instructions that, when executed by at least one of the one or more computing devices, cause at least one of the one or more computing devices to store the one or more control data structures in a secured folder structure further cause at least one of the one or more computing devices to, for each control data structure in the one or more control data structures:
assign the control data structure to a secured folder in the plurality of secured folders based at least in part on a compliance status of the control corresponding to that control data structure; and
transmit one or more automated alerts relating to a control corresponding to the control data structure, wherein the one or more automated alerts are based at least in part on the secured folder assigned to the control data structure.

31. The at least one non-transitory computer-readable medium of claim 25, wherein the at least one control data structure and the one or more uploaded artifacts linked to the at least one control data structure are stored in a first secured folder in a plurality of secured folders of the secured folder structure, and wherein the secured folder structure is configured to provide the auditor authenticated access to the first secured folder.

32. The at least one non-transitory computer-readable medium of claim 31, further storing computer-readable instructions that, when executed by at least one of the one or more computing devices, cause at least one of the one or more computing devices to:
receive a confirmation from the auditor indicating that the one or more uploaded artifacts satisfy at least one control corresponding to the at least one control data structure; and
transfer the at least one control data structure and the one or more uploaded artifacts from the first secured folder to a second secured folder in the plurality of secured folders based at least in part on the received confirmation.

33. The at least one non-transitory computer-readable medium of claim 31, further storing computer-readable instructions that, when executed by at least one of the one or more computing devices, cause at least one of the one or more computing devices to:
receive a rejection from the auditor indicating that at least one uploaded artifact in the one or more uploaded artifacts does not satisfy at least one control corresponding to the at least one control data structure; and
transfer the at least one control data structure and the one or more uploaded artifacts other than the at least one uploaded artifact that does not satisfy the at least one control from the first secured folder to a second secured folder in the plurality of secured folders based at least in part on the received rejection; and
update a version number associated with the at least one control data structure.

34. The at least one non-transitory computer-readable medium of claim 25, further storing computer-readable instructions that, when executed by at least one of the one or more computing devices, cause at least one of the one or more computing devices to:
calculate one or more metrics based at least in part on one or more of: the audit information, compliance status of the one or more controls associated with the audit, information corresponding to one or more other audits; and
transmit a representation of the one or more metrics.

35. The at least one non-transitory computer-readable medium of claim 34, wherein the audit information comprises severity information associated with a severity of risk, likelihood information associated with a likelihood of a risk, and detectability information associated with detectability of a risk and wherein the instructions that, when executed by at least one of the one or more computing devices, cause at least one of the one or more computing devices to calculate one or more metrics further cause at least one of the one or more computing devices to:
calculate an overall risk score for the audit based at least in part on a severity metric associated with the severity information, a likelihood metric associated with the likelihood information, and a detectability metric associated with the detectability information.

36. The at least one non-transitory computer-readable medium of claim 35, further storing computer-readable instructions that, when executed by at least one of the one or more computing devices, cause at least one of the one or more computing devices to:
identify one or more remedial actions based at least in part on a determination that the overall risk score is above a predetermined threshold; and
transmit the one or more remedial actions to a user.
